(19) United States
(12) Patent Application Publication
(10) Pub. No.: US 2019/0210096 A1
(43) Pub. Date: Jul. 11, 2019

(54) CUTTING EDGE WITH COLD FORGED NOTCHES TO ENHANCE CUTTING PERFORMANCE

(71) Applicant: Darex, LLC, Ashland, OR (US)

(72) Inventor: Daniel T. Dovel, Shady Cove, OR (US)

(73) Assignee: Darex, LLC

(21) Appl. No.: 16/355,251

(22) Filed: Mar. 15, 2019

Related U.S. Application Data
(62) Division of application No. 15/298,179, filed on Oct. 19, 2016.

(51) Int. Cl. B21K 11/02; B23P 15/28; B21K 11/06; B24B 3/58

(52) U.S. Cl. CPC B21K 11/02; B24B 3/586; B21K 11/06; B23P 15/28

(57) ABSTRACT

Method for enhancing sharpness of a cutting tool. A blade portion is cold forged by applying a force to a first side of the blade portion using a form tool projection to form a notch such that a portion of the metal material from the first side of the blade is work hardened and plastically deformed to extend through a plane along which the second side extends. A secondary grinding operation is applied to the second side of the blade portion to remove the portion of the metal material that extends beyond the plane along which the second side extends and sharpen a cutting edge extending between the first and second sides. The form tool projection is a radially extending projection of a rotatable knurl roller which rotates to form a sequence of spaced apart cold forged notches along the cutting edge.

### RELATED APPLICATION

The present application is a divisional of copending U.S. patent application Ser. No. 15/298,179 filed Oct. 19, 2016.

### BACKGROUND

Cutting tools are used in a variety of applications to cut, separate or otherwise remove material from a workpiece. A variety of cutting tools are well known in the art, including but not limited to knives, scissors, shears, blades, chisels, spades, machetes, saws, drill bits, etc.

A cutting tool often has one or more laterally extending, straight or curvilinear cutting edges along which pressure is applied to make a cut. The cutting edge is often defined along the intersection of opposing surfaces that intersect along a line that lies along the cutting edge.

Cutting tools can become dull over time after extended use. It can thus be desirable to subject a dulled cutting tool to a sharpening operation to restore the cutting edge to a greater level of sharpness. A variety of sharpening techniques are known in the art, including the use of grinding wheels, whet stones, abrasive cloths, etc. While these and other sharpening techniques have been found operable, there is a continued need for improved blade configurations that extend cutting performance by reducing the need for frequent resharpening operations.

### SUMMARY

Various embodiments of the present disclosure are generally directed to method for shaping a cutting tool so as to have enhanced cutting performance.

In some embodiments, a blade portion is cold forged by applying a force to a first side of the blade portion using a form tool projection to form a notch such that a portion of the metal material from the first side of the blade is plastically deformed to extend through a plane along which the second side extends. The portion of material that is deformed is work hardened by the cold forging process. The form tool projection is a radially extending projection of a rotatable knurl roller which rotates during retraction of the blade portion to form a sequence of spaced apart cold forged notches along the cutting edge. A secondary grinding operation is applied to a second side of the blade portion to remove the portion of the metal material that extends beyond the plane along which the second side extends and sharpen a cutting edge extending between the first and second sides.

These and other aspects of various embodiments of the present disclosure will become apparent from a review of the following detailed description in conjunction with the accompanying drawings.

### BRIEF DESCRIPTION OF THE DRAWINGS

FIG. 1 is an exemplary cutting tool having a sequence of cold forged notches formed in accordance with various embodiments of the present disclosure.

FIG. 2A is an elevational representation of a portion of the cutting tool of FIG. 1.

FIG. 2B is an isometric depiction of FIG. 2A.

FIG. 2C is a cross-sectional representation of the cutting tool.

FIGS. 3A-3D illustrate cross-sectional profiles of different exemplary cutting tools having notches similar to those set forth in FIGS. 2A-2C.

FIGS. 4A-4D illustrate a sharpening sequence applied to a cutting tool to form notches similar to those provided in the cutting tool of FIG. 1 in accordance with some embodiments.

FIGS. 5A-5D show aspects of a cutting tool similar to the cutting tool of FIGS. 4A-4D.

FIGS. 6A-6F are photographs of a cutting tool similar to the cutting tool of FIG. 1 to illustrate features represented in FIGS. 5A-5D.

FIGS. 7A-7B depict a cold forging operation using a knurl roller to form notches (also called channels) of the types generally illustrated in FIGS. 6A-6F in accordance with some embodiments.

FIG. 8 illustrates the use of an abrasive member in the form of an endless abrasive belt to carry out the secondary grinding operation of FIG. 5C.

FIG. 9 shows the use of an abrasive member in the form of a rotatable abrasive disc to carry out the secondary grinding operation of FIG. 5C, where the cutting member engages a side of the abrasive disc.

FIG. 10 illustrates the use of an abrasive member as an array of rotatable abrasive discs to carry out the secondary grinding operation of FIG. 5C, where the cutting member engages and advances along the perimeters of the abrasive discs.

FIG. 11 illustrates the use of an abrasive member in the form of an elongated abrasive rod to carry out the secondary grinding operation of FIG. 5C.

FIGS. 12A-12C show a hand-held, multi-stage manual sharpener that can be utilized to effect the sharpening sequence of FIGS. 5A-5D in some embodiments, the sharpener having multiple sharpening stages including an embedded knurl roller as in FIGS. 7A-7B.

FIG. 13 shows another hand-held, multi-stage manual sharpener that may be utilized in accordance with some embodiments to effect the sharpening sequence of FIGS. 5A-5D.

FIG. 14 shows yet another hand-held, multi-stage manual sharpener that may be utilized in accordance with some embodiments to effect the sharpening sequence of FIGS. 5A-5D.

FIG. 15 shows a powered, multi-stage sharpener that may be utilized in accordance with some embodiments to effect the sharpening sequence of FIGS. 5A-5D.

FIG. 16 is a cutting tool sharpening routine illustrative of steps carried out in accordance with some embodiments to sharpen a cutting tool.

FIGS. 17A-17E show another sequence that may be carried out in accordance with some embodiments to form a cutting tool with cold forged notches.

FIGS. 18A-18F illustrate a fabrication process that uses a primary grind, a cold forge press assembly, and a secondary grind to form a cutting tool in some embodiments.

FIG. 19 is a cutting tool manufacturing routine illustrative of steps carried out in accordance with some embodiments to form a cutting tool such as illustrated in FIGS. 17A-17E and FIGS. 18A-18E.

FIGS. 20A-20C illustrate a fabrication process that uses a cold forge press assembly and a secondary grind without the need for a prior primary grind to form a cutting tool in some embodiments.

FIGS. 21A-21C illustrate a cold forge press assembly that can be used to generate a series of cold forged notches.

FIG. 21D illustrates a secondary grinding operation referenced during the processing of FIGS. 20A-20D.

FIG. 22 is a cutting tool manufacturing routine illustrative of steps carried out in accordance with some embodiments to form a cutting tool such as illustrated in FIGS. 20A-20D and FIGS. 21A-21D.

FIG. 23 is a graphical representation of exemplary test data obtained from the extended use of a blade having cold forged notches as exemplified herein.

FIG. 24 shows a sequence of blade portions that may be subjected to various processing steps in accordance with some embodiments.

### DETAILED DESCRIPTION

The present disclosure is generally directed to cutting tools, and more particularly to providing a cutting edge of a metal blade portion of a cutting tool with series of notches to enhance cutting characteristics of the tool.

As explained below, the notches extend through opposing sides of the blade portion adjacent the cutting edge. The notches can be immediately adjacent one another to provide “teeth” as short extents between adjacent notches, or the notches can be spaced apart to provide relatively long linear or curvilinear extents of the cutting edge between the adjacent notches.

The notches extend down into and through the blade portion to provide u-shaped surfaces, or notches, that extend from a first side of the blade to an opposing second side of the blade. The notches provide recessed cutting surfaces that extend down below the top extent of the cutting edge. More specifically, each notch has a base surface that is recessed with respect to the top extent of the cutting edge, and the base surface has opposing ends which intersect and adjoin opposing tapered surfaces of the blade. Substantially triangular notch surfaces extend upwardly from the base surface to form recessed cutting edges where the notch surfaces adjoin the side surfaces of the blade. The recessed cutting edges retain their cutting capacity even if the topmost extent of the cutting edge becomes dulled from extended use. In this way, the presence of the notches significantly extends the operational life of the blade from a cutting performance standpoint.

The notches can take a wide variety of dimensional sizes, from microscopic (e.g., not visible to the unaided eye of a typical human observer) to relatively large notches easily seen by a typical human observer. Any number of notches can be provided per linear inch of cutting edge, such as but not limited to 1-2 notches per inch up to several tens or hundreds of notches per linear inch or more.

The notches are formed using a cold forging process so that the metal material of the blade portion in the vicinity of the notches is work hardened, which enhances the strength of the various recessed surfaces. As will be appreciated, work hardening, or strain hardening, is a characteristic whereby an existing ordering of atoms in a metallic lattice is enhanced through the application of localized mechanical force. The mechanical energy imparted by the plastic deformation of the material serves to impart increased localized hardness to the material.

For purposes of the present discussion, cold forging will be understood in accordance with its ordinary and customary meaning as the application of mechanical deformation to a blade at an ambient temperature, such as in the region of a normal room temperature such as around 20-25 degrees Celsius, C., to induce plastic deformation of the metallic material to a desired localized change in shape and locally work harden the material. Some heating may be applied in some embodiments, so long as the temperature of a magnetic metal remains well below its Curie temperature (e.g., the temperature at which a ferromagnetic material loses its magnetic orientation), such as, but not limited to, at least 100 degrees C. below this temperature or more. Non-magnetic materials may also be subjected to such processing, so reference to a Curie temperature is merely for illustration and is not limiting. This is in contrast to what is commonly referred to as hot forging, which is defined consistent with its ordinary and customary meaning as heating a metal blade to a temperature to a sufficient temperature (including a magnetic material above its Curie temperature) to enable shaping the blade through mechanical deformation to change the crystalline structure of the blade material and impart an overall shape to the metal material (such as, for example, a curvilinearly extending blade, etc.). Work hardening does not occur during hot forging.

Another aspect of various embodiments disclosed herein is a secondary sharpening, or grinding, operation that is carried out upon the blade portion after the cold forging process has been completed. It is contemplated that the notch or notches formed in a given blade portion will result from the application of mechanical force to a first side of the blade portion. This will cause an extension (e.g., stretching) of the blade material, in each localized notch area, through the blade geometry such that a portion of the blade material extends past a planar extent of an opposing, second side of the blade portion. The first and second sides may taper to form the cutting edge, but such is not necessarily required. The extended material may take a generalized “cup shape” through the second side.

The secondary grinding operation is subsequently applied to remove the distended material that projects beyond the second side of the blade portion, thereby nominally returning the second side of the blade to its previous planar form and providing a well defined, generally u-shaped notch that extends from the first side to the second side of the blade portion.

The techniques disclosed herein can be readily applied to any number of different types of cutting tools, including knives, saws, blades, chisels, axes, scrapers, razors, arrow heads, etc. The following discussion will commence with a detailed review of sharpening processing that may be applied to an existing cutting tool (such as a kitchen knife) to which the cold forging and secondary grinding operations are applied to enhance the cutting performance of the existing cutting edge of the tool. After this discussion, further embodiments will contemplate various manufacturing operations in which cutting tools can be originally formed having the notches provided therein as a part of the originally manufactured article.

### Sharpening Processing

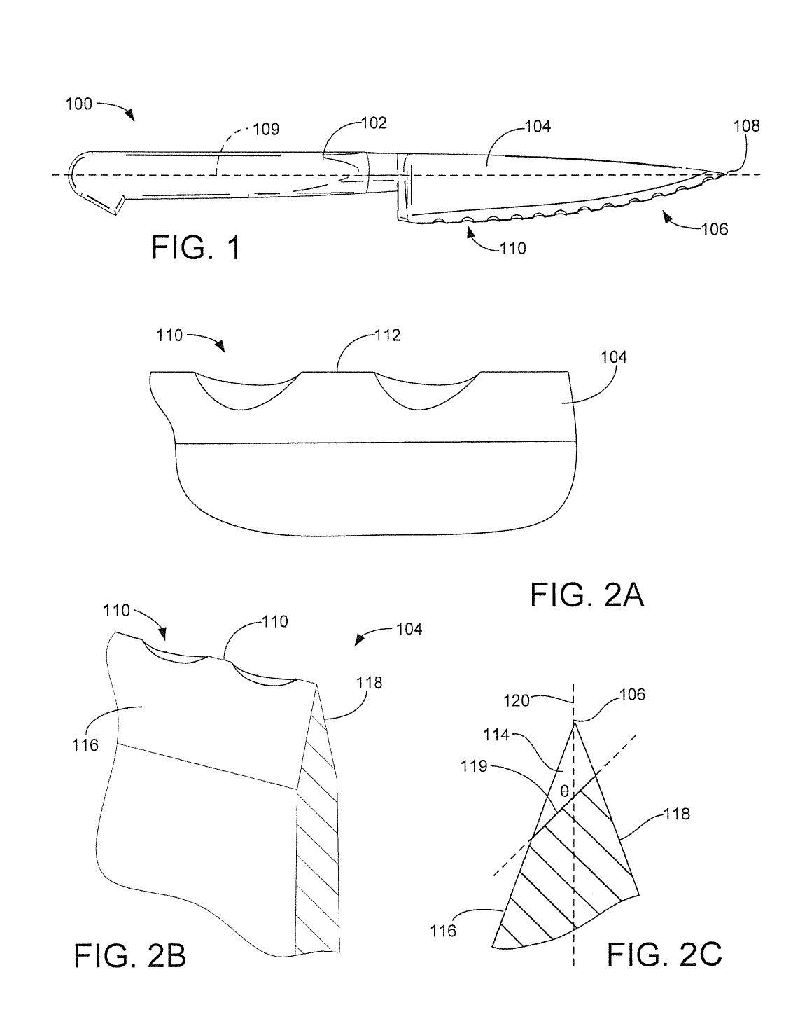

FIG. 1 shows an exemplary cutting tool 100 constructed in accordance with some embodiments. As explained below, the cutting tool has a specially configured cutting edge with a number of cold forged notches configured to enhance the cutting performance of the tool. As noted above, the notches extend the operational life of the tool by maintaining the cutting edge in an effectively “sharp” condition, thereby reducing the need to apply resharpening operations to the tool.

The cutting tool 100 is characterized as a kitchen knife, although such is merely exemplary and is not limiting as the notches disclosed herein can be applied to substantially any type of cutting tool. The knife 100 includes a handle 102 and a blade 104. The handle 102 is sized to be grasped by the hand of a user during cutting operations. The blade 104 is formed of a suitable metal or metal alloy, including but not limited to a steel, stainless steel, etc., and has a continuously extending cutting edge 106 which extends along the length of the blade from a position proximate the handle 102 to a distal end 108 of the knife. The handle 102 and blade 104 are aligned along a central axis 109 of the knife that extends along a longitudinal direction of the blade.

The knife 100 includes a plurality of spaced apart notches 110 in the cutting edge 106. As further shown in FIGS. 2A-2C, the notches 110, also sometimes referred to as channels, recesses, grooves, etc., provide relatively small discontinuous zones between continuous segments 112 of the cutting edge 106. Each notch 110 is formed by an interior sidewall 114 that extends into the body of the blade 104 from a first side surface 116 to a second side surface 118 of the blade. A base portion or surface 119 of the sidewall, best viewed in FIG. 2C, is oriented at a selected angle θ with respect to a medial (in this case, vertical) plane 120 that extends through the blade 104.

More details concerning the notches 110 will be given below, but at this point it will be understood that the notches are relatively small and are formed using a cold forging process in which localized force is applied to deform and locally work harden the metal material of the blade in the vicinity of each notch. For reference, the various notches may be described as macroforged notches or microforged notches.

As used herein, the term macroforged notches will be understood as notches of the size that can be clearly seen by a human observer, such as those illustrated in FIGS. 1 through 2C. Any suitable dimensions can be used for the macroforged notches, such as on the order of about 0.25 inches (in.) in length along the length of the cutting edge 106. Other sizes and arrangements of macroforged notches can be used, including sizes that are larger or smaller than 0.25 inches in length. The term microforged notches as used herein will be relatively smaller notches of the size that cannot be clearly seen by a human observer without the use of magnification (e.g., a microscope, etc.), such as on the order of around 0.005 in. of width along the length of the cutting edge 106. Other sizes and shapes can be used.

While it is contemplated that all of the notches 110 along a given cutting edge 106 will nominally be the same size, such is not required; in some embodiments, different sizes of notches can be provided, including both macroforged notches and microforged notches along the same cutting edge. In other embodiments, microforged notches can be formed between or within macroforged notches.

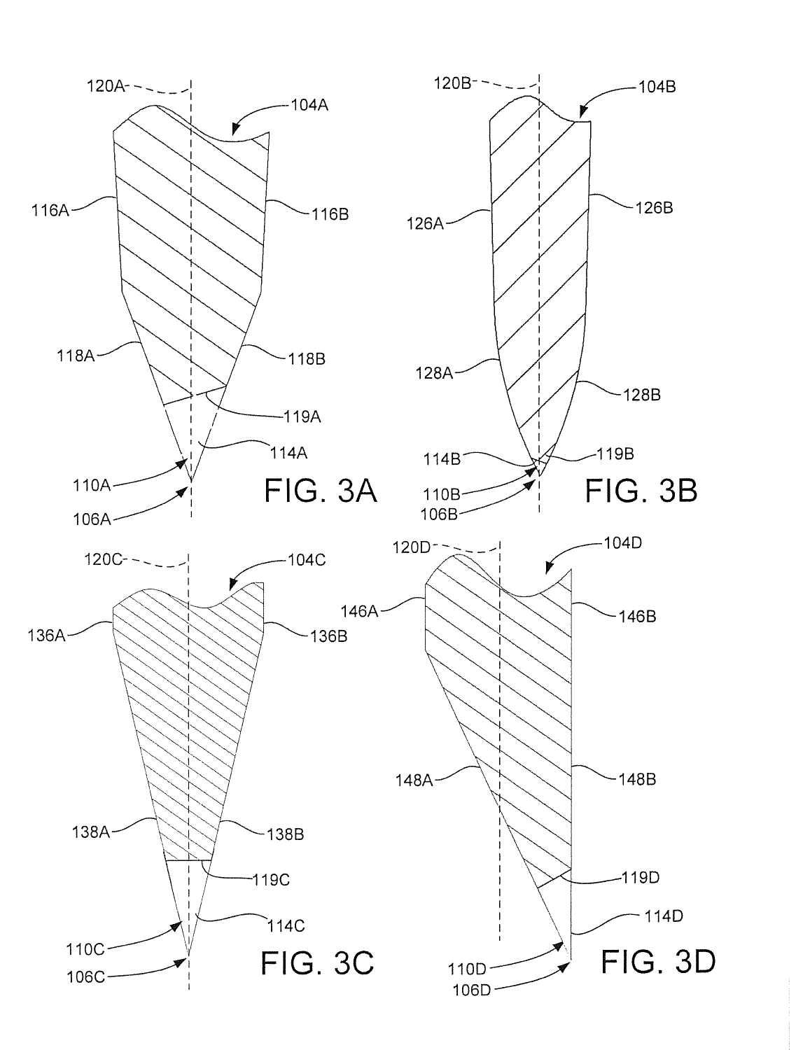

FIGS. 3A-3D show blades 104A, 104B, 104C and 104D to illustrate other forms of cold forged notches that may be generated in accordance with various embodiments. The blade 104A in FIG. 3A has a multi-beveled, double sided geometry formed of side surfaces 116A, 116B and side surfaces 118A, 118B which taper to cutting edge 106A. A macroforged notch 110A is formed by interior sidewall 114A. The sidewall 114A has a base portion 119A that extends at a non-orthogonal angle with respect to centerline 120A and adjoins sidewalls 118A, 118B. In multi-faceted geometries such as illustrated in FIG. 3A, also sometimes referred to as micro-beveled geometries, the notches 110A can take any suitable shapes and depths, including notches large enough to intersect surfaces 116A and 116B, as desired. It will be appreciated that the micro-bevel formed by secondary beveled surfaces 118A, 118B may operate to enhance the cutting performance of the blade.

Blade 104B in FIG. 3B shows a microforged notch 110B that extends through cutting edge 106B formed by opposing convex ground surfaces 126A, 126B and 128A, 128B. The respective convex surfaces are provided with different radii of curvature as shown to strengthen the blade and enhance cutting performance of the cutting edge 106B. Interior side surface 114B of notch 110B is generally u-shaped with base portion 119B extending as shown with respect to centerline 120B.

Blade 104C in FIG. 3C has a hollow ground grinding geometry with opposing side surfaces 138A, 138B tapering to cutting edge 106C. Macroforged notch 110C is formed by interior surface 114C, with a base portion 119C that is substantially horizontal (e.g., perpendicular to midline 120C).

Blade 104D in FIG. 3D takes a single sided tapered grind configuration with tapered sidewall 148A and flat sidewall 148B which converge to cutting edge 106D. Sidewall 148A is angled with respect to centerline 120D, and sidewall 148B is nominally parallel with centerline 120D. Macroforge notch 110D is formed by interior sidewall 114D with base surface 119D which adjoins respective sidewalls 148A, 148B as shown.

From these exemplary drawings it will be recognized that any number of different blade grinding geometries, and relative sizes and placements of macroforged and microforged notches, can be combined as required for a given application, so that the various grinding and notch geometries shown in these figures are merely exemplary and are not limiting.

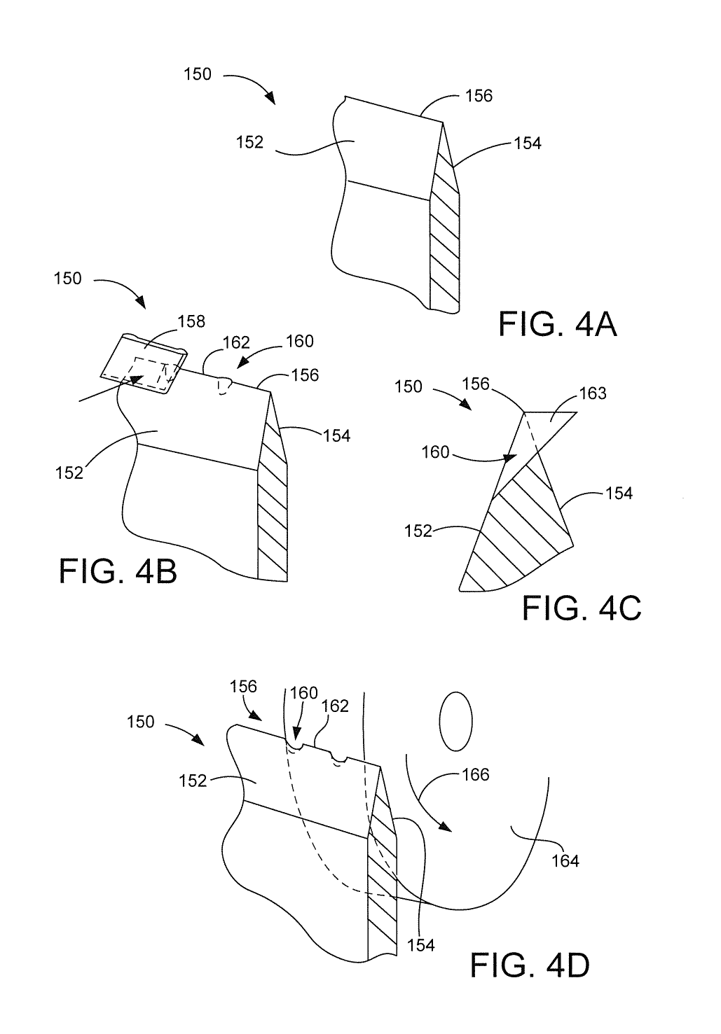

FIGS. 4A through 4D are schematic depictions of a process that can be used in accordance with some embodiments to provide notches as discussed above to an existing blade. An exemplary blade 150 is depicted in FIG. 4A with opposing surfaces 152, 154 which taper to an elongated cutting edge 156. As desired, a preliminary (e.g., a primary) grinding (sharpening) operation can be supplied as desired to the respective surfaces 152, 154 to effect the illustrated geometry. Mechanisms and methodologies suitable for such operation will be discussed below.

FIG. 4B shows the application of a cold forging tool 158 to locally deform, via a cold forging process, a sequence of notches 160 that extend through the cutting edge 156. Further details regarding suitable arrangements of cold forging tools such as 158 will be discussed below. It will be noted that the notches 160 provide linear extents of cutting edge portions 162 between the adjacent notches that remain at the top extent of the cutting edge 156. Each of the notches 160 extends down through the blade material, to form generally cup shaped deformations. A portion of the displaced material 163 extends beyond the second surface 154, as generally depicted in FIG. 4C. This displaced material may also be referred to as a projection, since the material projects beyond the planar surface 154. While the top of the cup shaped extension in displaced material 163 is shown to be nominally level with the topmost extent of the cutting edge 156, in other forging operations the top of the cup may extend downwardly from edge 156.

FIG. 4D illustrates the use of a grinding wheel 164 that rotates in direction 166 to remove the distended material 163 from FIGS. 4B-4C and to realign back surface 154 to a nominally planar configuration. The resulting shape of the blade 150 at the end of the grinding operation is similar to that shown above in FIG. 2C.

The wheel 164 incorporates an abrasive surface of abrasive material suitable to remove the extended material. Any number of different forms of mechanisms can be utilized to carry out the secondary grinding operation.

At this point, it will be understood that the term “notch” is used to describe the resulting deformation structure in the blade both before and after the secondary grinding operation. More specifically, the cold forging operation forms work hardened cup-shaped notches (channels, recesses, etc.), such as depicted in FIGS. 4B and 4C. Once the secondary grinding operation has been applied to remove the projections (distended material, etc.), the notches can be viewed as u-shaped notches (channels, recesses, etc.) such as depicted in FIG. 4D. The removal of the projections provides the notches with newly exposed cutting edges at the boundary of the interior u-shaped notch surface and the adjoining side surfaces of the blade.

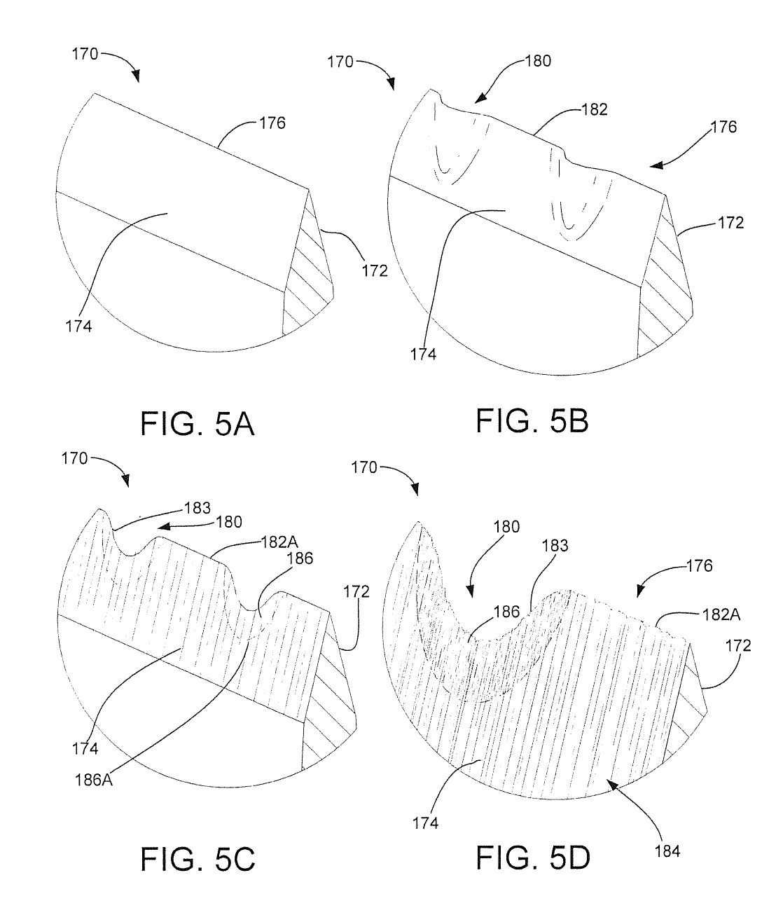

FIGS. 5A-5D illustrate another blade 170 sharpened in accordance with some embodiments. For reference, FIGS. 5A-5D show a view of the blade opposite that shown in FIGS. 4A-4D, so the “back side” or “protrusion side” of the blade is visible in FIGS. 5A-5D, whereas the “front side” or “recessed side” of the blade is most clearly shown in FIGS. 4A-4D. The blade 170 is similar to the blades discussed above and is formed of a suitable metal material. Opposing first and second surfaces 172, 174 taper to form an elongated cutting edge 176. A cold forging tool (not shown) is utilized to form localized notches 180, as depicted in FIG. 5B. The notches are generally u-shaped and include cup-shaped protrusions that extend through the second surface 174, as before. Linear extents 182 remain disposed along the top extent of the cutting edge 176 between adjacent ones of the notches 180, also as before.

FIG. 5C depicts a number of sharpening lines 184 (e.g., scoring marks) imparted to the blade material after a secondary sharpening operation applied to both surfaces 172, 174. It will be appreciated that the lines 184 indicate the direction of relative travel of the abrasive media applied to the respective surfaces 172, 174 (in this case, substantially orthogonal to the cutting edge 176). Those skilled in the art will appreciate that the lines are formed by abrasive media (e.g., diamond particles, etc.) that operate to remove material from the blade portion responsive to relative motion of the abrasive media and the blade 180. While not visible in FIG. 5C, it will be understood that surface 172 may have similar scoring marks a similar or mirrored direction and orientation as shown on surface 174. Other relative orientations of the score marks with respect to the cutting edge 176 can be provided, although it is contemplated that, to enhance material removal, the direction of the secondary grinding operation (and hence, the resulting score marks) will be non-parallel to the cutting edge 176.

From FIG. 5C it can be seen that the application of the secondary grinding operation removed the cup-shaped distended material from the surface 174 so that, in FIG. 5C, work hardened areas 186 are substantially coterminous with the nominal planar layout of surface 174. Application of the material removal operation reveals new recessed cutting edges 183 disposed between sharpened linear segments 182A and the work hardened areas 186 adjacent each notch 180.

FIG. 5D is a close up representation of a portion of the view in FIG. 5C, and shows further details of the work hardened area 186 of a selected one of the notches 180. The shaded area illustrates the work hardened material and the resulting refined/improved grain structure. The dotted line 186A represents the approximate boundary of work hardened material.

FIG. 5D shows a non-parallel grind finish is supplied to the distal extents 182A and 183 so that a small amount of jaggedness (toothiness) is imparted to these sections of the cutting edge 176. The level of polish (and hence, uniformity) along these sections 182A will depend on a number of factors, including the grit (e.g., size and aggressiveness of the abrasive), the duration of the secondary grinding operation, and so on. In some cases, the final configuration of the sections 182A and 183 may be substantially linear without such toothiness, which may be described as a so-called polished finish. Multiple levels of secondary sharpening with successively finer amounts of abrasive (including finishing with a leather strope, etc.) may be used to impart a polished finish, as desired.

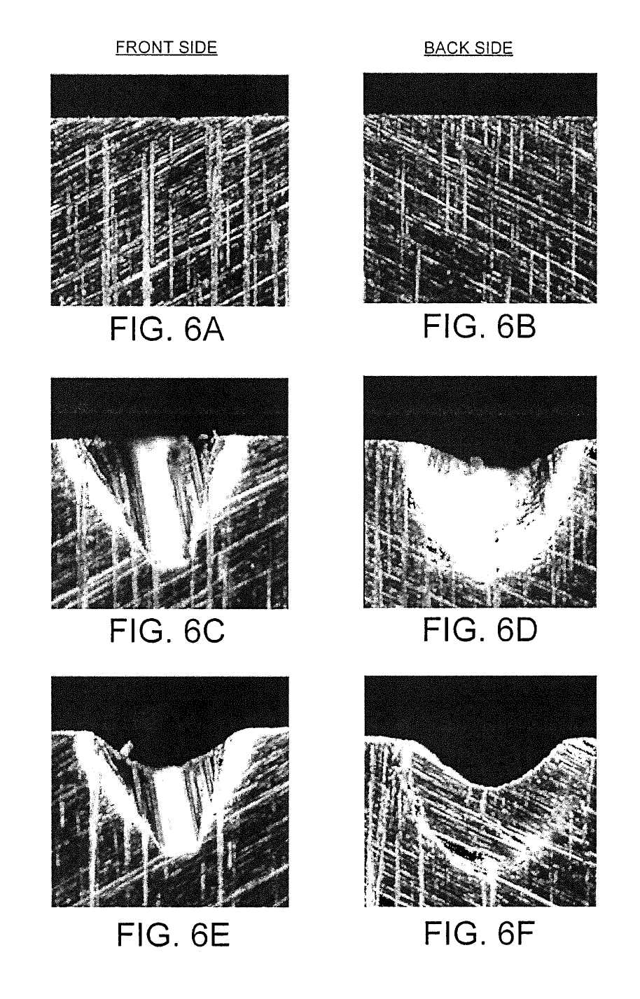

FIGS. 6A-6F are photographs of a blade portion subjected to processing similar to that depicted in FIGS. 5A-5D. FIGS. 6A, 6C and 6E show a front, or recessed side of the blade portion, and FIGS. 6B, 6D and 6F show corresponding views of the back, or protrusion (distended) side of the blade portion. The cold forging process is applied from the recessed side, and the secondary grinding operation is applied to the protrusion side.

Various grinding directions are indicated by the associated score marks visible in the respective photographs. For example, FIGS. 6A and 6B show substantially horizontal cutting edge marks and canted grinding marks at a selected angle, such as at about 40 degrees with respect to horizontal. These marks correspond to sharpening operations applied to tapered surfaces 172, 174 in FIG. 5A. In some cases, a relatively coarse grinding operation may be applied initially to aggressively remove material, followed by a relatively fine grinding operation to polish out and smooth the final desired geometries of the surfaces.

The interior recess of the cup shaped notch formed by the cold forging process is best viewed in FIG. 6C. The exterior of the cup shaped notch is shown in FIG. 6D and generally corresponds to the previously discussed configuration of FIG. 5B. FIGS. 6E and 6F show the blade after the secondary grinding operation. FIG. 6F generally corresponds to FIG. 5C. Additional grinding marks are visible in FIG. 6F that depict the grinding operation used to remove to extended material and bring surface 174 back into planar alignment. While it appears the secondary grinding operation was carried out at the same angle as the previous canted grinding operation shown in FIG. 6B, other angles non-parallel to the cutting edge segments can be used to remove the extended material.

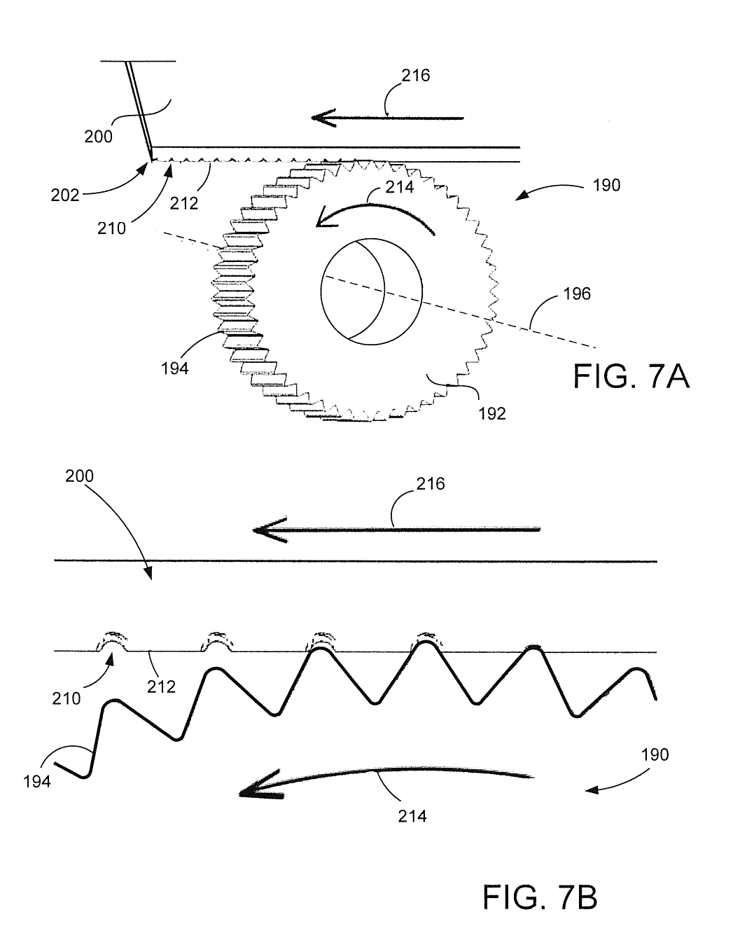

FIGS. 7A-7B show a rotatable knurl roller 190 that can be used to form the various cold forged notches in the respective blade portions discussed above. The knurl roller 190 comprises a hard cylindrical member made of metal or other suitable material with a projection pattern about an exterior circumference thereof configured to be transferred to a corresponding workpiece upon the application of force thereto.

In the embodiment of FIGS. 7A-7B, the knurl roller 190 takes a gear configuration with a cylindrical body 192 and radially spaced, radially and longitudinally extending teeth (projections) 194. The teeth are substantially triangular in shape, although other shapes, spacings and patterns of projections can be used including irregular patterns and sequences of projections. It will be appreciated that an irregular pattern of projections on an associated roller will nonetheless provide a repeatable pattern of notches and segments on each of a population of blades that are each individually subjected to the associated roller.

The roller 190 is adapted to rotate about a roller axis 196, which is selected to be at a selected angle with respect to a presentation path for an associated blade 200 having a cutting edge 202. The knurl roller 190 forms a sequence of notches 210 and intervening segments 212 along the cutting edge 202. With reference back to FIGS. 3A-3D, the rotational angle of the knurl roller 190 will, assuming equidistant projection geometries as depicted in FIG. 7A, nominally establish the angle of the base portion of the notch surface (see e.g., surfaces 119, 119A-D in FIGS. 2C, 3A-3D).

The knurl roller 190 forms the notches using the aforedescribed cold forging process (also referred to as a roll forming process). As each tooth projection 194 encounters a different point along the blade 200 in turn, the localized surface pressure causes a localized mechanical deformation of the blade material. The blade 200 may be moved (e.g., retracted) by a user along the knurl roller 190 so that the roller rotates about the axis 196 and rolls along the length of the cutting edge 202 of the blade 200 (or a desired portion thereof). The teeth 194 of the roller 190 come into contact with, and locally deform, the cutting edge 202 as the roller 190 rotates about rotational direction 214 and the blade 200 is translated linearly along direction 216.

The surface pressure imparted by the teeth 194 cold forges (deforms or displaces) the material of the blade 200 to form the spaced apart projecting notches 210 along the length of the cutting edge 202. The displaced material will project beyond the planar extent of the opposing surface in relation to the relative angle θ between the roller axis and the blade axis (see 120A-120D in FIGS. 3A-3D), the magnitude of the force F between the blade and the roller, and the respective material configuration of the blade and the roller. As noted previously, the deflected material is subsequently removed using a suitable secondary grinding (honing) operation to align the notch wall with the exterior tapered surfaces of the blade.

An advantage of the use of a cold forging process to form the notches is the quick and easy manner in which the features can be generated. A single pass of the blade against the knurl roller (or other forging member) while applying moderate force upon the blade may be sufficient in most cases to form the respective notches. Although the applied force is light, the resulting surface pressure is relatively high because only a single projection, or a few projections, are in contact with the blade at any given time, and the projections are so small that the applied pressure is high.

Secondary honing can be applied with a single or a few strokes of the blade to remove the displaced material. Substantially any knife or other cutting tool can be subjected to this processing. Another advantage of cold forging is that, depending upon the material, the metal of the blade in the vicinity of the notches will be work hardened, thereby providing localized zones of material with enhanced hardness and durability as the material is locally deformed, which enhances the durability of the recessed cutting surfaces formed by the notches.

To the extent that subsequent passes are required to re-form the notches during a subsequent resharpening operation, the knurl roller 190 will tend to align with the existing notches 210 so that the notches are formed in the same locations during subsequent cold forging passes. Such alignment has been found to occur because the distal ends of the knurl teeth 194 tend to engage the existing notches as the cutting edge 202 is drawn across the roller 190. Once engaged, the roller 190 will turn in a keyed fashion to the previously embossed pattern of notches. Any number of rollers can be concurrently applied to the blade to form different channel patterns. In another embodiment, the blade 200 can be held stationary and the roller 190 can be rollingly advanced therealong to form the notches 210. Motive power can be applied to the blade 200 and/or the roller 190 during the channel forming process as desired.

While it is contemplated that the secondary grinding operation is applied to the protrusion side of the cutting tool to remove the distended material (e.g., the projections), the recessed side of the cutting tool can also be subjected to the same grinding operation. In each case, the cutting tool is moved (e.g., retracted) against an abrasive member to sharpen the cutting edge. The tool may be retracted a single time, or multiple times in succession as required.

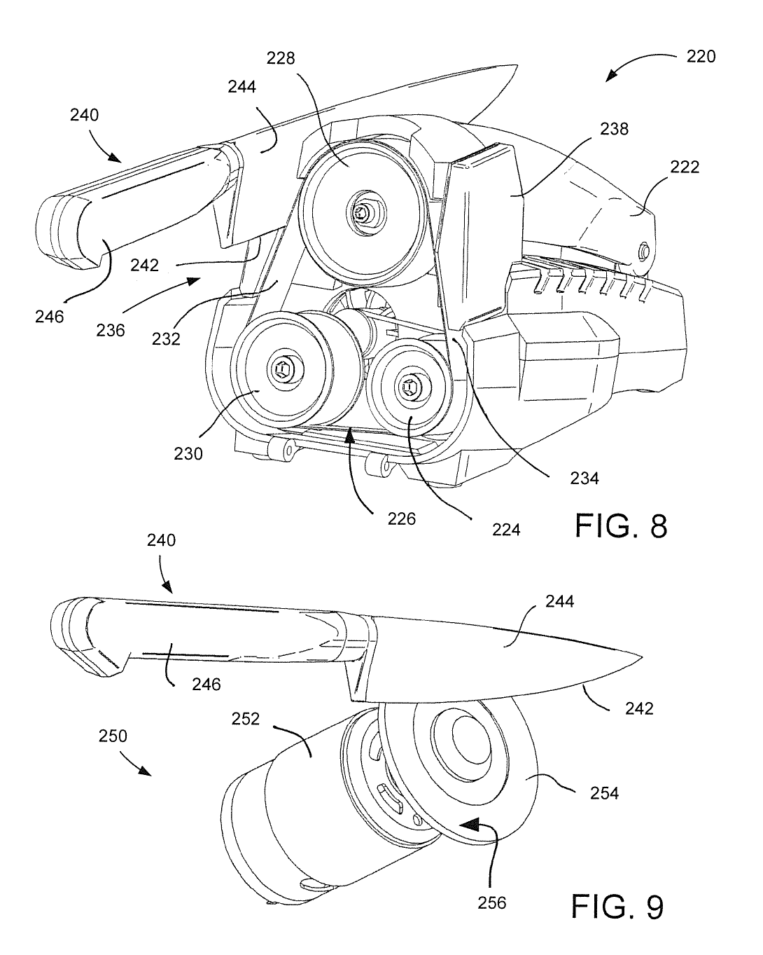

FIG. 8 shows a powered belt sharpener 220. A housing 222 encloses an electric motor (not shown) that drives a powered roller 224. An endless abrasive belt 226 is routed along a belt path that passes around the powered roller 224 as well as a pair of idler rollers 228, 230. The belt path provides a substantially triangular shape, exposing opposing linear extents 232, 234 of the belt.

Slotted guides 236, 238 allow a cutting tool (kitchen knife) 240 to be controllably placed against each of the linear extents 232, 234 of the belt and retracted so that a cutting edge 242 of a blade portion 244 of the knife 240 is sharpened along a length thereof. The user may grasp a handle 246 of the knife during the sharpening operation to move the blade 244 adjacent the belt 226. The guides 236, 238 include guide surfaces configured to maintain the blade portion 244 at a selected angle with respect to the linear extents 232, 234. The unsupported linear extents 232, 234 will tend to wrap about the presented sides at a selected radius of curvature based on a number of factors including tension supplied to the belt, stiffness of the belt, etc.

A convex grinding geometry as depicted in FIG. 3B will be imparted by the sharpener 220 to the knife 240. The different curvilinear surfaces 126A, 126B and 128A, 128B in FIG. 3B can be imparted using different belts with different levels of abrasiveness and different linear stiffnesses.

FIG. 9 shows another powered sharpener 250 in which an electric motor 252 is configured to rotate an abrasive disk 254 at a selected rotational velocity. The disk 254 has a substantially disk shaped abrasive surface 256 against which respective sides of the knife 240 are presented to remove the distended material and sharpen the cutting edge 242. Aspects of the sharpener 250, such as a housing, guides, etc. have been omitted from FIG. 9 for purposes of clarity of illustration, but can be provided to control the sharpening process.

It is contemplated that the abrasive disk 254 is a rigid disk, so that the disk does not deform during presentation of the blade 244 thereagainst. In some cases, the disk or blade may be provided with a biasing member, such as a spring, that limits an overall surface pressure that may be supplied to the blade. A beveled sharpening geometry can be provided by the sharpener 250, such as in FIGS. 3A and 3D. Different presentation angles, such as through the use of multiple disks and corresponding guides, can provide a multi-faceted, microbeveled sharpening profile as shown in FIG. 3A.

In other embodiments, the disk 254 may be configured as a flexible disk, so that the disk locally deforms adjacent the blade 244 in a curvilinear fashion. This will tend to provide a convex grinding geometry similar to the belt-based sharpener 220 of FIG. 8.

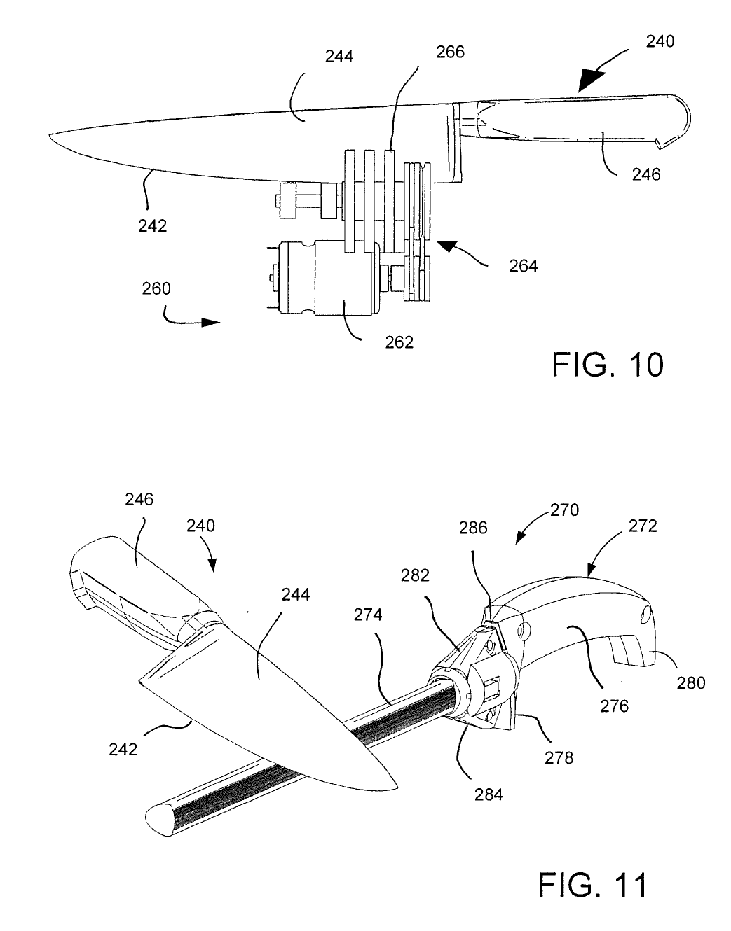

FIG. 10 shows yet another powered sharpener 260 in accordance with some embodiments. As with FIG. 9, FIG. 10 omits a number of features of interest for clarity of illustration. The sharpener 260 includes an electric motor 262. The motor rotates a drive transfer assembly 264 which, in turn, rotates a plurality of adjacent, spaced apart abrasive disks 266 at a selected rotational velocity. While three (3) disks 266 are shown, any number of such discs can be provided.

Each of the disks 266 has an abrasive surface along an outermost perimeter thereof, similar to the grinding wheel 164 in FIG. 4D. The knife 240 is retracted against these abrasive surfaces to effect the sharpening operation.

FIG. 11 illustrates a hand-held manual sharpener 270 in accordance with further embodiments. The sharpener 270 includes a user handle 272 and an abrasive rod 274 which extends from the handle as shown. An outer grip surface 276 is provided with sufficient clearance using leg support portions 278, 280 to enable a user to grasp and press the sharpener 270 against a base surface, such as a table top or counter, using a first hand of the user. Alternatively, the sharpener 270 may be held by the first hand of the user in “free space” in non-contacting relation to such base surface.

The handle 272 includes a pair of opposing guide surfaces 282, 284 which extend adjacent a proximal end of the rod 274 at a selected angle, such as nominally 20-25 degrees, etc. The angle corresponds to the final desired sharpening geometry, which will be tapered in accordance with this angle (see FIG. 3A). In other embodiments, the surfaces 282, 284 extend at different angles to facilitate micro-beveling.

To sharpen the knife 240, the user grasps the handle 246 and places a side of the blade 244 in contact against a selected one of the guides, such as the top guide 282. This provides a reference for the rotational orientation of the blade. Next, the user advances the blade along the length of the rod 274 while nominally maintaining the rotational orientation constant as established by the guide. As the blade is advanced, the user may further retract the blade across the rod so that the entirety of the cutting edge 242 engages, and is sharpened by, the rod. As noted above, this process may be repeated as desired, such as 3-5 times. It will be noted that the sharpener 270 takes the form of a sharpening steel. In one example, the sharpener 270 may be held vertically so that the distal end of the rod is supported on the base surface, providing ready access to both guide surfaces 282, 284 to allow opposing sides of the blade 244 to be sharpened.

The abrasive rod 274 can be formed of any suitable abrasive material, including a ceramic rod, a steel or other metal material, etc. The rod 274 may be rotatable so that different surfaces with different abrasiveness levels can be aligned with the guides.

As desired, a knurl roller as 190 in FIG. 7A can be housed within the handle 272 of the sharpener 270. The knurl roller axis can be placed at a selected orientation with respect to the angle of the guides 282, 284 to effect a desired sharpening geometry. A guide slot 286 allows the user to draw the blade 244 across the roller prior to the secondary sharpening operation along the abrasive rod 274.

The roller and slot are preferably arranged such that the user can retract the blade through the slot with a selected side of the blade facing the abrasive rod, after which the user can place the opposing side of the blade onto the guide surface 282 and commence with removal of the distended material induced by the roller. The other sharpeners 220, 250 and 260 can also be configured to incorporate a knurl roller to allow similar processing.

12A-12C show another hand-held manual sharpener 300 similar to the manual sharpener 270 of FIG. 11. The sharpener 300 has a base portion 302 with an outer surface 304 that may serve as a user grip surface. A body portion 306 is nested within the base portion 302, and can be slidingly advanced between a retracted position and an extended position.

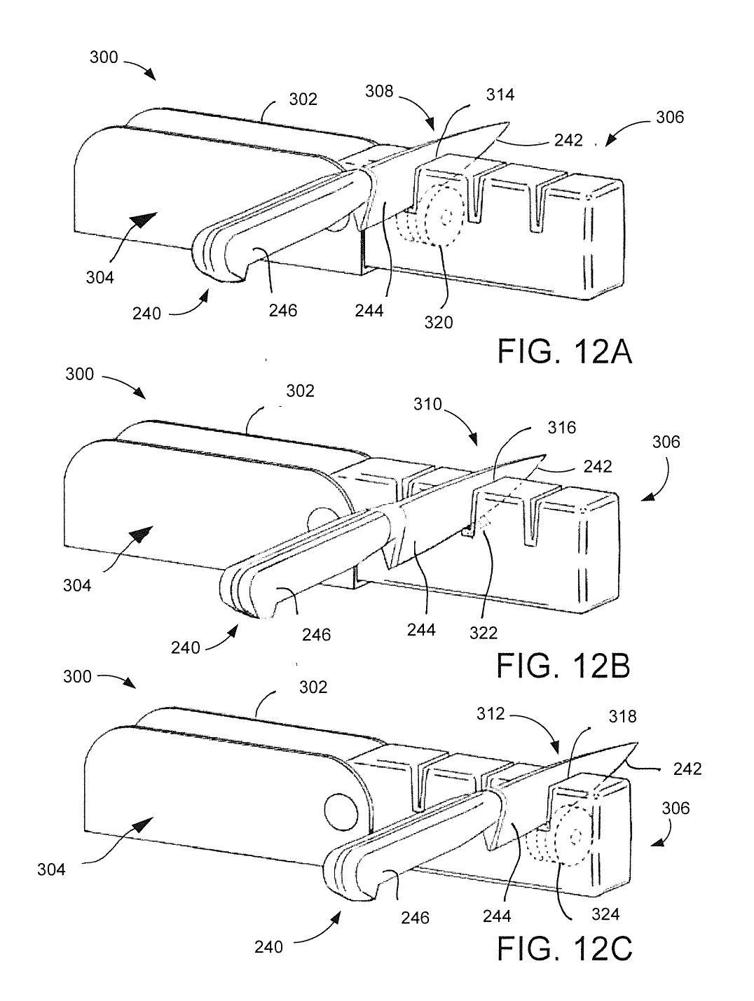

The body portion 306 includes three (3) sharpening stages: a first stage 308 (FIG. 12A), a second stage 310 (FIG. 12B) and a third stage 312 (FIG. 12C). It is contemplated that a multi-stage sharpening process may be applied to the knife 240 by sequentially subjecting the knife to each of these stages 308, 310 and 312 in turn. Each stage has a corresponding guide slot 314, 316 and 318 to accommodate insertion and retraction of the blade 244. One or more guide surfaces are supplied in each guide slot to enable the user to controllably move (e.g., retract) the knife in a desired orientation. While a single guide slot is provided in each stage, in other embodiments, each stage can be supplied with two (or more) guide slots. The use of two slots would allow separate insertion paths to sharpen opposing sides of the blade. The use of a single slot allows either the knife to be inserted in opposing directions, or the configuration of the sharpener can be established such that (as is the case here) both sides of the blade may be concurrently sharpened during a single pass through the associated slot.

As shown in FIG. 12A, the first stage 308 includes an interior abrasive member 320. The abrasive member is also referred to as a primary grinding member and may take the form of a pair of adjacent abrasive disks (grinding wheels). Other forms for the abrasive member 320 can be used. It is contemplated that the first stage 308 may be suitable for a coarse grinding operation in which relatively larger amounts of material may be removed from the blade 244. This may be desirable to address damage or wear to the blade sufficient to require a more aggressive reshaping of the blade material.

During normal sharpening of a given blade, the first stage may be skipped in most cases as being an unnecessary step, as the second and third stages may be sufficient to return the knife to a desired level of sharpness. A relatively smaller angle, such as 20 degrees, may be applied by the first stage 308 to the blade (see, e.g., side surfaces 116A and 116B in FIG. 3A, etc.). A sharpening operation in the first stage 308 generally includes insertion of the knife 240 into the guide slot 314 and retraction of the knife, via handle 246, one or more times against the abrasive member 320.

FIG. 12B shows the second stage 310 to include a cold forging member 322, which may take the form of a knurl roller such as the knurl roller 190 in FIG. 7A. The cold forging member may instead take some other suitable configuration. A sharpening operation using the second stage 310 may involve insertion of the knife 240 into the guide slot 316 and retraction of the knife, via handle 246, a single pass so that the cold forging member 322 forms cold forged notches along the desired length of the cutting edge 242.

FIG. 12C shows the third stage 312 to include an interior abrasive member 324, also referred to herein as a secondary grinding member. The member 324 is shown to take the form of a pair of abrasive disks, but other forms may be used. As discussed above, the secondary grinding operation supplied by the third stage 312 operates to remove the distended material that was plastically deformed by the second stage 310 and to bring the back side of the blade 244 to a nominally planar configuration. As before, sharpening using the third stage 312 generally involves insertion of the blade 244 into the slot 318 and user retraction of the handle 246 so that the cutting edge 242 is moved (retracted) in contacting engagement with the abrasive member 324. This may be carried out one or more times; in one embodiment, 3-5 times should be sufficient.

The guide slot 318 of the third stage 312 may be configured to provide a larger angle to the blade 244 as compared to the guide slot 314 of the first stage 308. In one embodiment, the guide slot 318 may establish an angle of nominally about 25 degrees (see e.g., surfaces 118A, 118B in FIG. 3A). Other suitable values can be used.

In one exemplary sequence in which relatively little wear is present on the knife 240, the knife may first be subjected to initial sharpening in the third stage 312, followed by the cold forging of the notches in the second stage 310, followed by the final shaping of the blade by returning to the third stage 312. In another exemplary sequence in which larger amounts of wear and/or damage are present, the foregoing steps may be preceded by an initial subjecting of the knife 240 to the first stage 308. Other suitable processing sequences can be used; for example, if the cold forged notches are still effective, just the third stage 312 may be used, and so on.

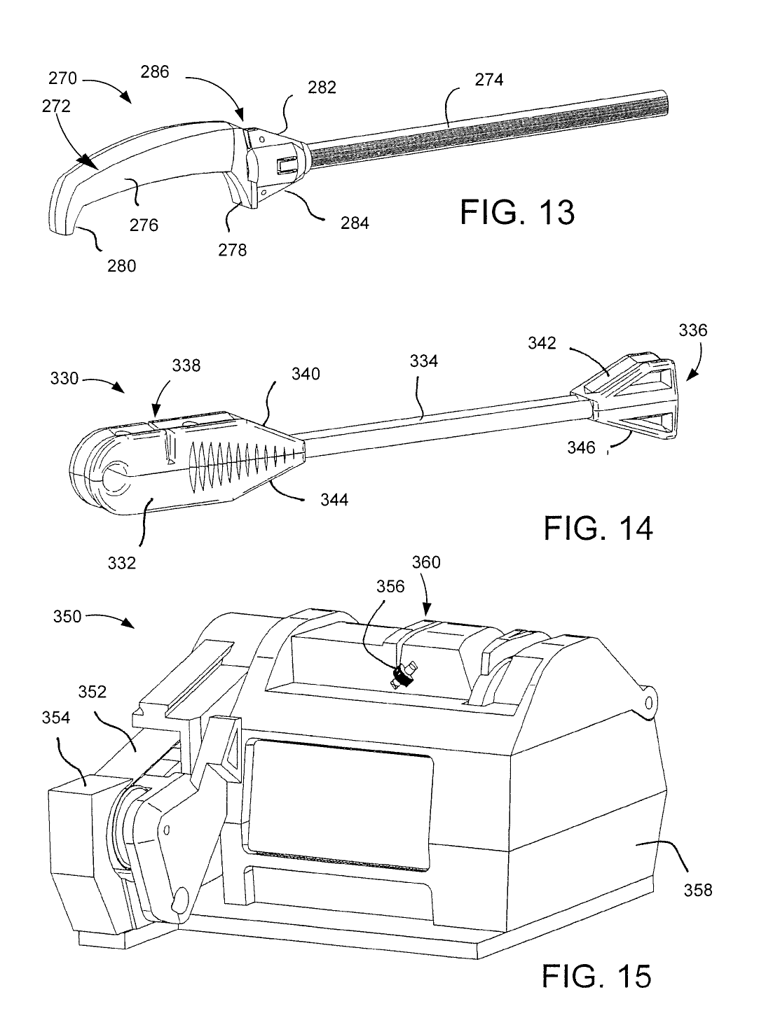

FIG. 13 provides another view of the hand-held manual sharpener 270 from FIG. 11. FIG. 14 shows a similar hand-held manual sharpener 330 with a handle 332, abrasive rod 334, distal support 336, and slot 338 to facilitate access to an embedded rotatable knurl roller (or other cold forging member). The abrasive rod 334 takes a generally rectangular (square) cross-sectional shape. Other shapes can be used. In some cases, the distal support 336 can be used to support the sharpener 330 on a base surface during a sharpening operation.

Guide surfaces 340, 342, 344 and 346 can be used as described above to orient the blade during a sharpening operation along the abrasive rod 334. Different angles may be supplied depending on the desired angle of the final blade geometry for the opposing side surfaces through which the cold forged notches extend.

In one embodiment, guide surfaces 340 and 342 may be at a first angle (such as nominally 20 degrees, etc.) and guide surfaces 344, 346 may be at a different, second angle (such as nominally 25 degrees, etc.). The angle may be selected to be the same as, or different from, the rotational axis about which the knurl roller rotates (see FIG. 7A). The angle of the base portion of the notches (see e.g., surface 119 in FIG. 2A) may warrant the use of a larger or smaller angle to the side surfaces.

FIG. 15 illustrates another powered sharpener 350 in accordance with some embodiments. The powered sharpener includes a power driven endless abrasive belt 352 with a flat guide surface 354 to support and advance the cutting edge of a cutting tool against the belt.

A knurl roller 356 is partially embedded within a housing 358 of the sharpener 350. Access to the roller is provided via guide slot 360. The housing 358 encloses other features as well, such as an electric motor to rotate the belt 352, control electronics, etc.

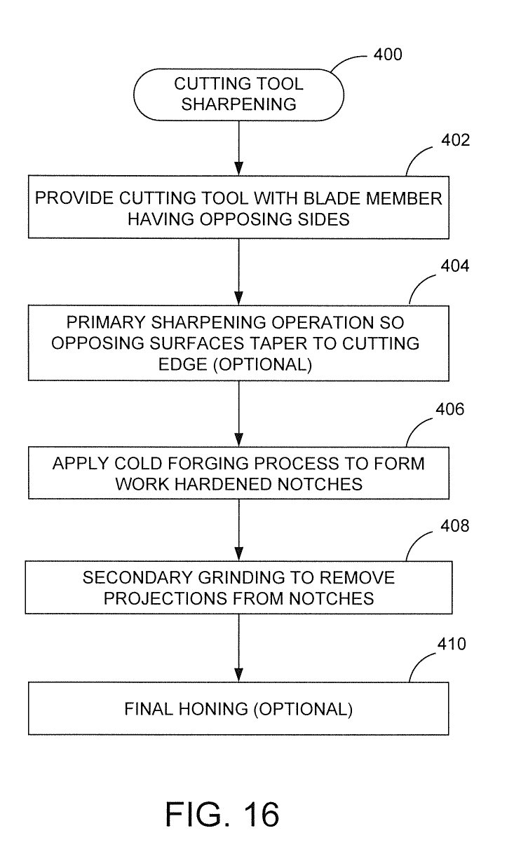

FIG. 16 is a flow chart for a cutting tool sharpening routine 400 illustrative of steps carried out in accordance with the foregoing discussion to sharpen an existing cutting tool, such as but not limited to a knife, using any suitable mechanisms including the various hand-held or power sharpeners discussed above. The various steps set forth in FIG. 16 are merely exemplary and may be omitted, modified, appended, performed in a different order, etc.

As shown by step 402, the process begins by providing a cutting tool (such as 240) with a metal blade member or portion (such as 244) having opposing sides that taper to form a cutting edge (such as 242). It is contemplated albeit not necessarily required that the knife or other cutting tool may be in a worn, dull state.

A primary sharpening operation is carried out at step 404 to initially shape the opposing edges and sharpen the cutting edge. While this is an optional step, it may be advantageous to initially define and sharpen the cutting edge prior to the cold forge processing, which is applied at step 406.

As discussed above, the cold forging processing forms a series of macroforged and/or microforged notches along the cutting edge. The blade material undergoes plastic deformation and localized work hardening during this processing step. Cup shaped notches with distended material projections will extend from a selected side (e.g., the back side) of the blade at the conclusion of this step.

Step 408 shows the application of a secondary grinding operation to remove the distended material projections from the back side of the blade. As desired, similar sharpening can be applied during this step to the front side of the blade as well. Because the projections will be work hardened, it is contemplated that the projections can be easily removed and the back side smoothed down to a planar shape.

Finally, as shown by step 410, a final honing operation may be supplied to further hone the respective front and back surfaces using a relatively fine grit of abrasive, such as but not limited to a leather strope, high grit value abrasive member, etc. This additional honing, or polishing, may further help to define the final front and back surfaces, the cutting edge and the boundaries of the respective cold forged notches.

### Cutting Tool Fabrication

Having concluded a discussion of various mechanisms and techniques that may be applied in accordance with various embodiments to form a series of cold forged notches in an existing cutting tool, the present discussion will now turn to mechanisms and techniques that may be applied to fabricate, or manufacture, a cutting tool with such notches. Many of the techniques discussed above can be incorporated into a fabrication process, so these details will not be repeated here for brevity.

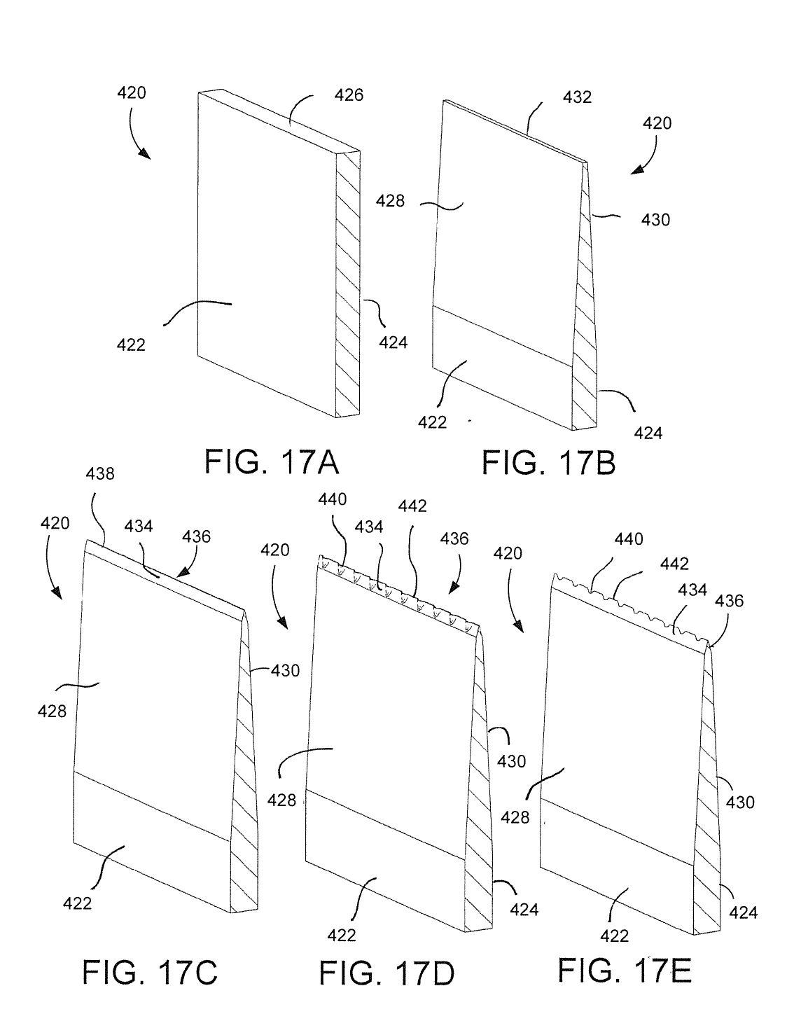

FIGS. 17A-17E show processing applied to a metal blank 420 that will ultimately form a portion of a finished cutting tool. For purposes of providing a concrete example, the cutting tool will be a knife similar to the kitchen knife 240 discussed above. It will be appreciated that only a portion of the metal blank 420 is shown in these drawings; in the case of a knife, the blank may take the form of a curvilinearly extending blade portion and a tang or similar attachment member to support the handle.

The blank may be shaped and prepared using a variety of processes. In one embodiment, a hot forging process is performed in which the metal blank is heated to a suitable high temperature above the Curie temperature of the metal, and mechanical deformation (such as through striking the blank with a hammer or other tool) is applied to place the blank in the final desired shape. Other processing may be applied at this point as well, such as heat treating which may involve quenching (rapidly cooling the heated blank in a cooling fluid such as oil, water, air, etc.) and tempering (slowing heating the quenched blank to a lower than hot forging temperature to relieve stresses).

As will be recognized, quenching helps to establish the crystalline lattice of the metal (e.g., stainless steel, carbon steel, etc.) atoms, but this includes stresses that, if not resolved, may leave the metal blank in a brittle state. The stresses are relieved during tempering, which also helps to locally orient individual bonds within the crystalline lattice. Such heat treating is not strictly necessary, and is therefore optional although many examples herein will contemplate the use of such processing.

It is contemplated that forging and heat treating has been supplied to the blank 420 as shown in FIG. 17A. Again, this is exemplary and not limiting. In other embodiments, relatively ductile blade metals (such as spring steel with a Rockwell Hardness of, say 20-55 HRC) may be stamped or otherwise processed to produce a blank such as 420 without undergoing additional forging or heat treatment. In still other embodiments, the blank may be cut from an existing sheet of material.

As shown in FIG. 17A, at this point the blank 420 has opposing sides 422, 424 which, while such may taper slightly toward each other, do not yet intersect to provide a clearly defined cutting edge. Instead, a bottom dull edge 426 may extend between the respective front and back sides 422, 424.

FIG. 17B shows application of one or more primary grinding operations to shape the front and back sides to provide primary beveled surfaces 428, 430 to a first angle, such as 20 degrees or some other value. These surfaces generally correspond to the tapered surfaces 116A, 116B in FIG. 3A, and may taper either to a sharp edge or narrow dull edge 432, as shown.

FIG. 17C shows application of an initial secondary grinding operation to further shape the front and back sides to provide secondary beveled surfaces 434, 436. The extent and angle of these surfaces can vary. This provides a well defined cutting edge 438 at the intersection of the beveled surfaces 434, 436.

FIG. 17D shows application of a cold forging operation as discussed above to form a sequence of cup-shaped notches 440 between segments 442 of the cutting edge 438. The notches can be formed using any of the various techniques discussed above, or other techniques discussed below. Finally, FIG. 17E shows application of a final secondary grinding operation to remove the distended material and provide the final notches 440 as substantially u-shaped notches.

In some cases, the various steps can be carried out in other orders. For example, relatively thinner blades may be formed using a single grind, rather than the double beveled grind profile shown in FIG. 17C. Similarly, relatively larger notches may induce significant stress to a given blade, particularly a thicker blade, so heat treating techniques (such as tempering) may be applied after the cold forging process, either prior to or after the secondary grind. A heat treatment operation may further be applied after the primary grinding operation (see e.g., FIG. 17B) and prior to the secondary grinding operation (see FIG. 17C).

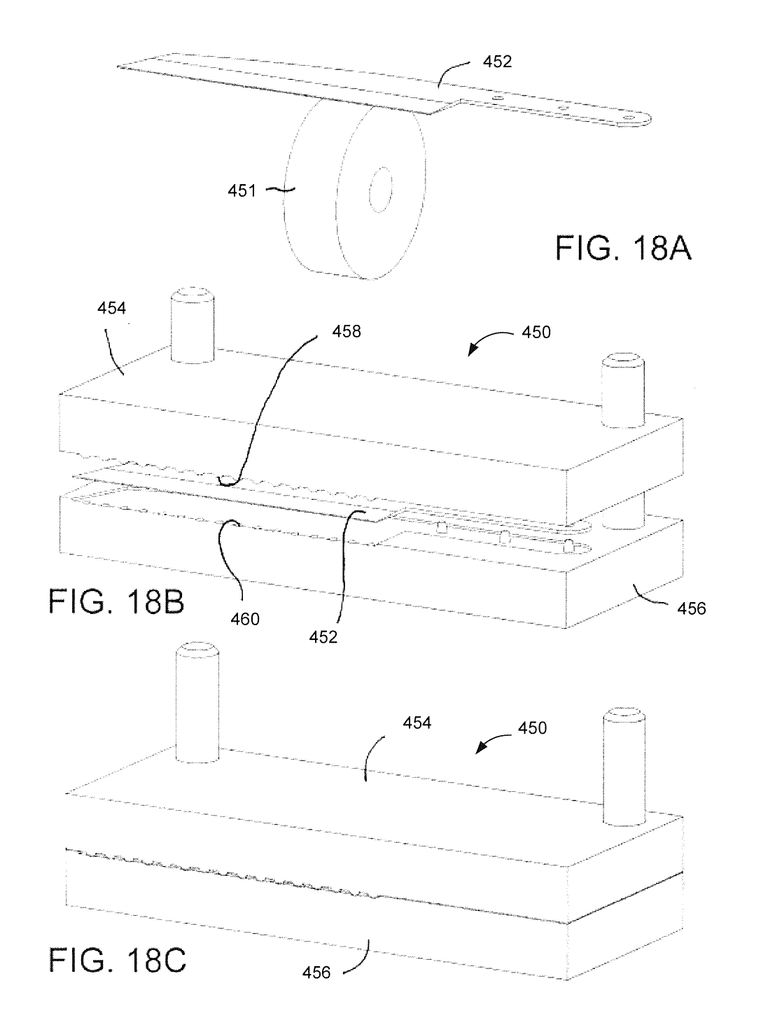

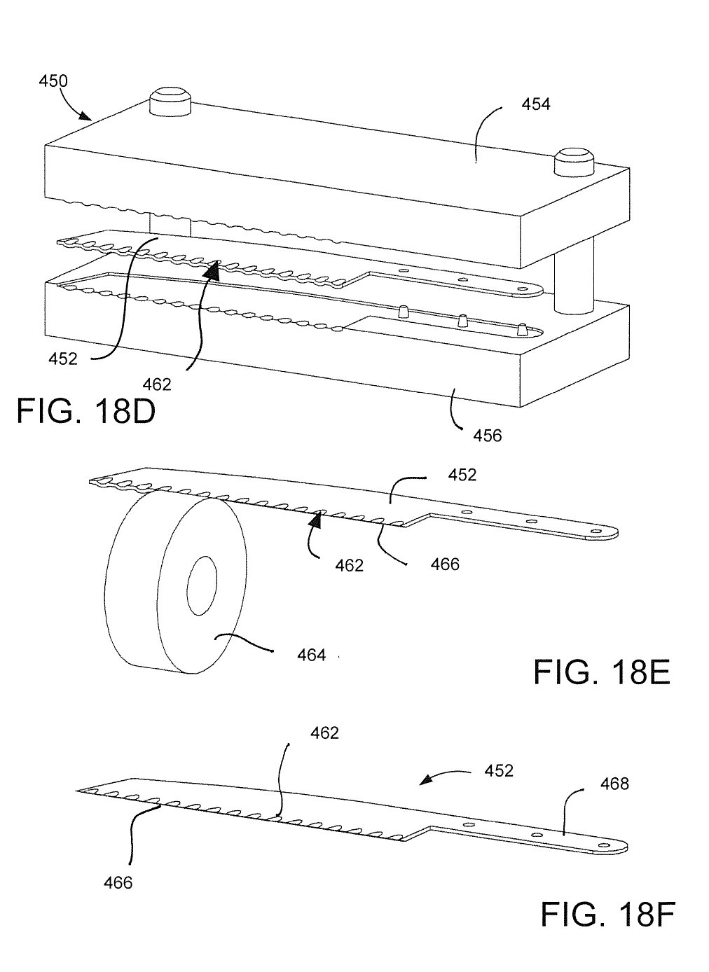

FIGS. 18A-18F show various processing steps that may be carried out corresponding to the sequence of FIGS. 17A-17E in some embodiments. Initially, as shown in FIG. 18A, a blank 452 is subjected to a preliminary shaping operation, such as by abrasive member 451 characterized as a rotatable grinding wheel. This thins the blank 452 in the vicinity of the eventual cutting edge.

The cold forging process is carried out using a press assembly 450 into which the shaped blank 452 is placed, as shown in FIG. 18B. The press assembly 450, also called a stamper assembly or stamper, includes upper and lower tooling members 454, 456 which are brought together under a relatively high amount of force. The upper tooling member 454 has a sequence of projections 458, and the lower tooling member 456 has a corresponding sequence of recesses 460 that align with the projections 458. In this way, as shown by FIGS. 18B through 18D, the blank 452 is cold forged between the respective members to provide a sequence of cup-shaped notches 462, with each notch formed from a different pair of the projections 458 and the recesses 460.

FIG. 18E shows a secondary grinding operation after the cold forging process in which the blank 452 is presented against an abrasive surface of an abrasive member 464, which in this case is a rotatable grinding wheel. The abrasive member 464 forms a final cutting edge 466 and removes the plastically deformed distended material from the back side of the blank.

FIG. 18F shows the final configuration of the blank 452 after the secondary grinding operation. Further processing can now be applied to the blank, including attachment of a handle to a tang portion 468 of the blank.

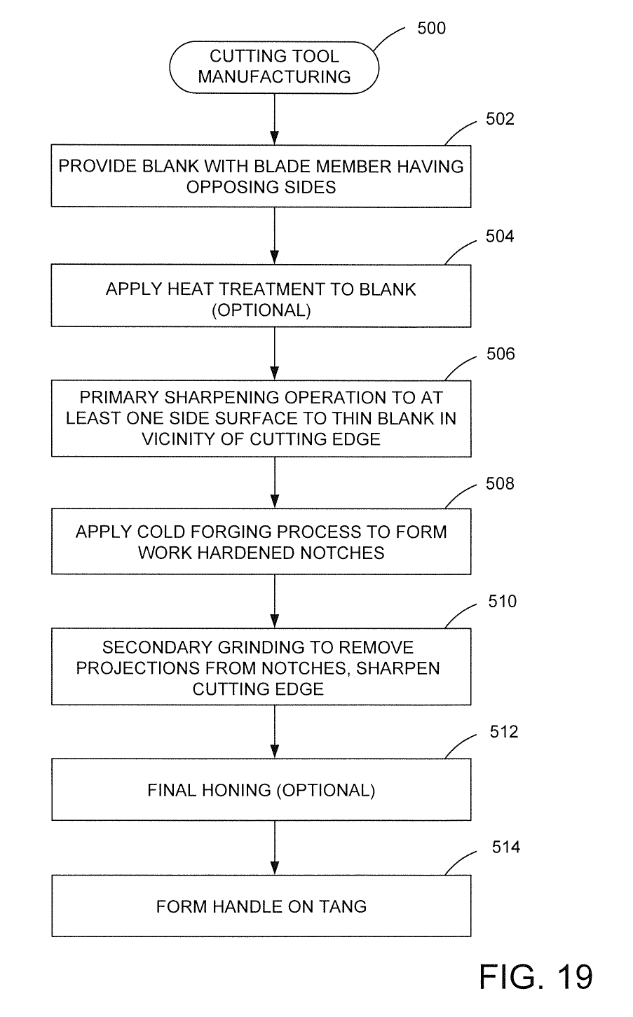

FIG. 19 provides a flow chart for a cutting tool manufacturing routine 500 to illustrate the foregoing discussion. The routine generally sets forth exemplary steps that may be carried out to form a cutting tool, such as but not limited to a knife, with microforged or macroforged notches originally manufactured into the tool. The various steps may be appended, omitted, carried out in a different order, etc.

As shown at step 502, an initial blank (such as the blanks 420, 452) of a suitable metal material is provided with opposing sides. The blank largely takes the profile of the final blade portion for the cutting tool, and may have other features as well such as the handle tang discussed above in FIG. 18E.

A heat treatment may be supplied to the blank at step 504. This may include heating, quenching and/or tempering operations to relieve stresses and increase the hardness of the metal. Heat treatments may be further interspersed at other locations during the routine, as discussed above.

Step 506 shows application of a primary shaping operation that may be supplied to at least one side of the blank in the vicinity of the cutting edge. This primary operation (grinding, forging, cutting, etc.) may be performed prior to the heat treatment of step 504, or may be omitted as desired.

A cold forging operation is next applied at step 508, such as by using a press assembly (e.g., 450, FIGS. 18B-18D). Other cold forging processes, including the use of one or more knurl rollers, can alternatively be used. As discussed above, the cold forging process plastically deforms the metal material to form cup-shaped, work hardened notches with projections that extend beyond an opposing second side of the blank.

A secondary grinding operation is carried out at step 510 to remove the projections and sharpen the cutting edge. A final honing operation may be carried out at step 512, and a handle may be attached to a tang portion of the blank at step 514.

The foregoing processing is contemplated as suitable for any number of different types and styles of cutting tools made from a wide variety of metal materials. The heat treating and other operations allow any range of thicknesses to be used.

The present discussion will now turn to further blade manufacturing techniques that may be used in addition to, or in lieu of, those discussed above, particularly with relatively thinner and softer metal materials. Heat treatments may be used but are not required. Grinding processing may also be simplified to provide lower cost tools.

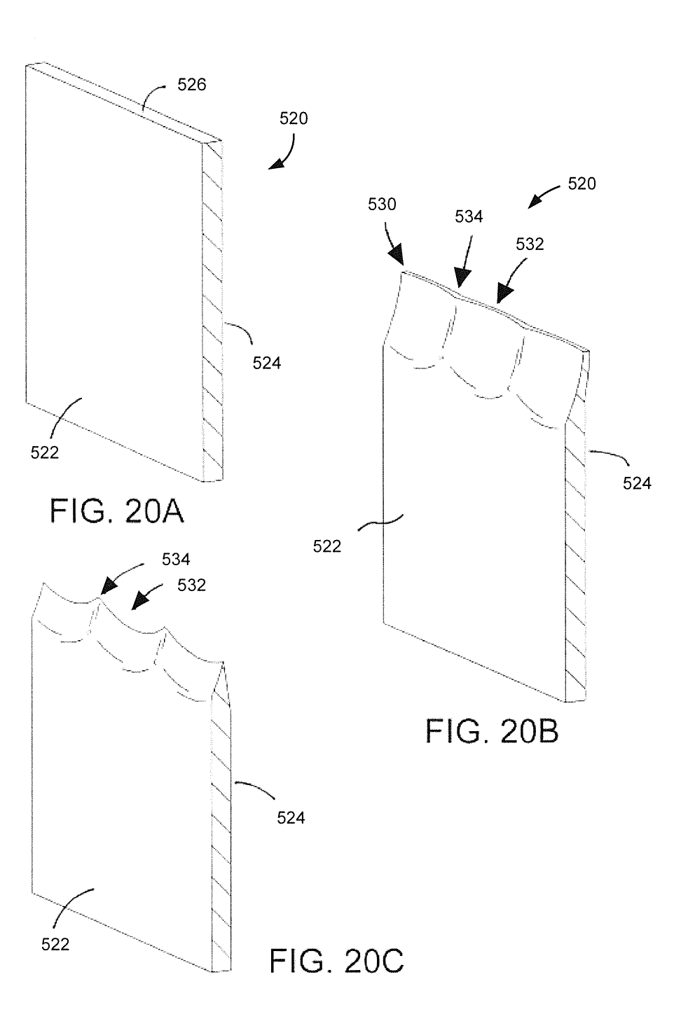

FIGS. 20A-20C illustrate a blank 520 from which a cutting tool, such as a kitchen knife, is to be manufactured. As before, the drawings only show a portion of the overall blank, which will have a suitable profile with a blade portion area and a tang area. The blank may be cut or stamped out of sheet metal, or generated by some other process. While the processing of FIGS. 20A-20C can be applied to a hot forged blank, it is contemplated for the present discussion that the blank is cut from a large roll of sheet steel with a Rockwell Hardness in the range of about 20-55 HRC.

As shown in FIG. 20A, the blank 520 includes opposing front and back sides 522, 524. The blank is largely rectangular and has edge surface 526. FIG. 20B shows application of a cold forging process to the blank 520 from FIG. 20A to generate cup shaped, work hardened notches 532 with segments 534 of a cutting edge 530 therebetween. The projections extend past the plane of the back side 524, and these are removed using a secondary grinding operation applied to the back side to provide the final configuration of FIG. 20C. It will be noted that this processing does not require a prior shaping operation (e.g., a primary grinding operation, etc.) prior to the cold forging process.

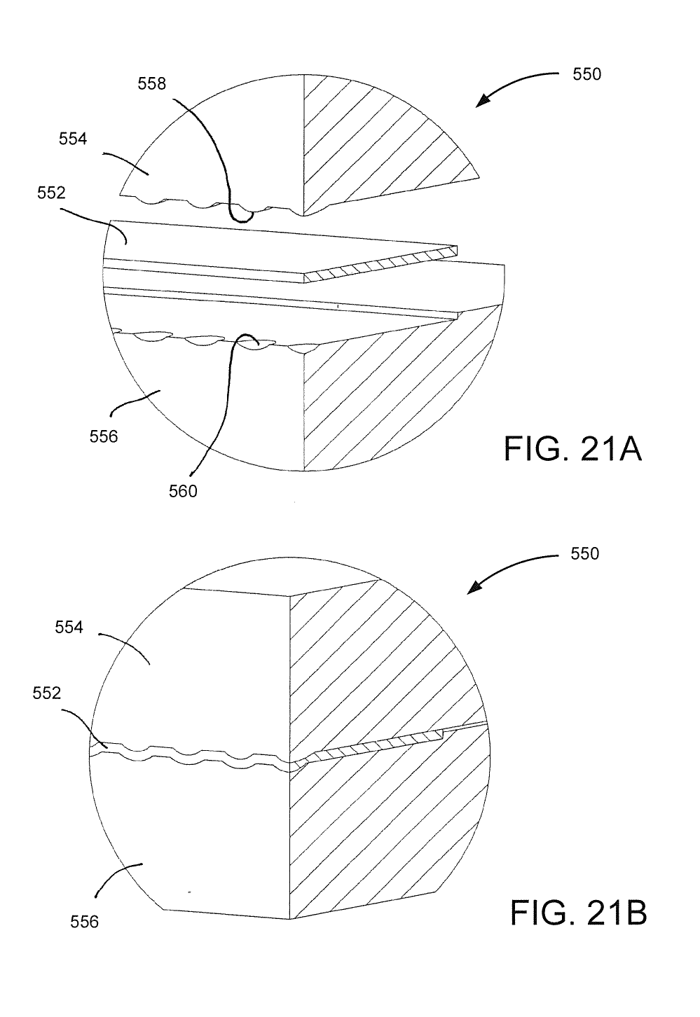

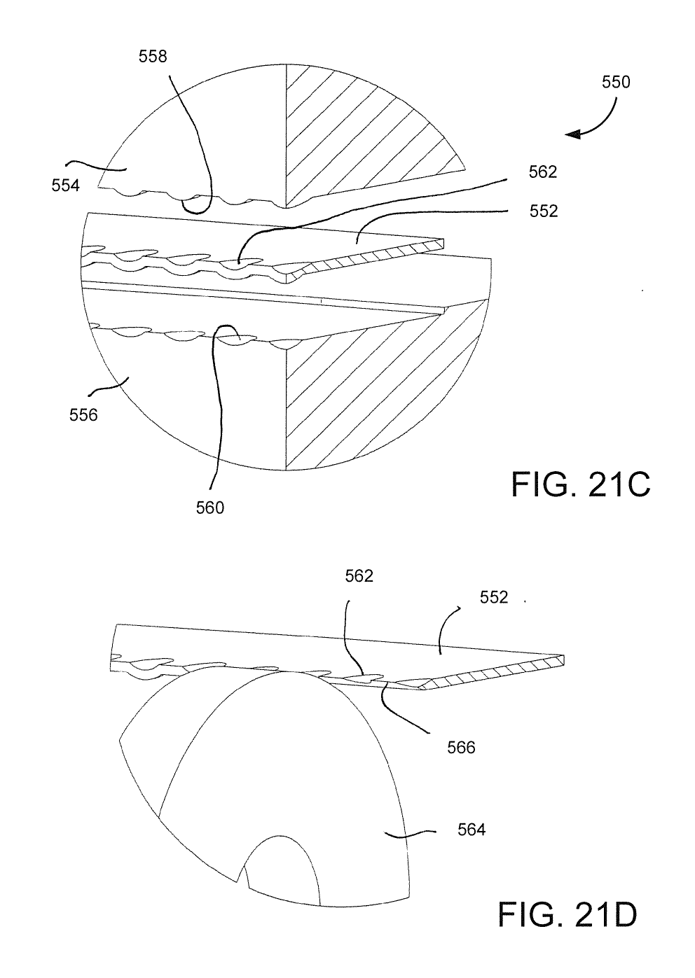

FIGS. 21A-21D illustrate another press assembly 550 that may be used to form the cold forged notches 532. The press assembly 550 is similar to the press assembly 450 and is used to process a blank 552 using upper and lower tooling members 554, 556. Depending on the strength and thickness of the metal material of the blank, primary grinding may be applied, or omitted, prior to the cold forging process.

The upper tooling member 554 includes a series of projections 558, which align with corresponding recesses 560 in the lower tooling member 554. In this way, the cold forging process can be carried out by compressing the blank 552 between the respective members 554, 556, as shown by FIGS. 21A-21C. The resulting notches are represented at 562.

FIG. 21D shows a secondary grinding operation using a grinding wheel 564 to remove the plastically deformed distended material and sharpen the blank to form a cutting edge 566. This sequence provides a lower cost, efficient way to manufacture high quality knives and other cutting tools.

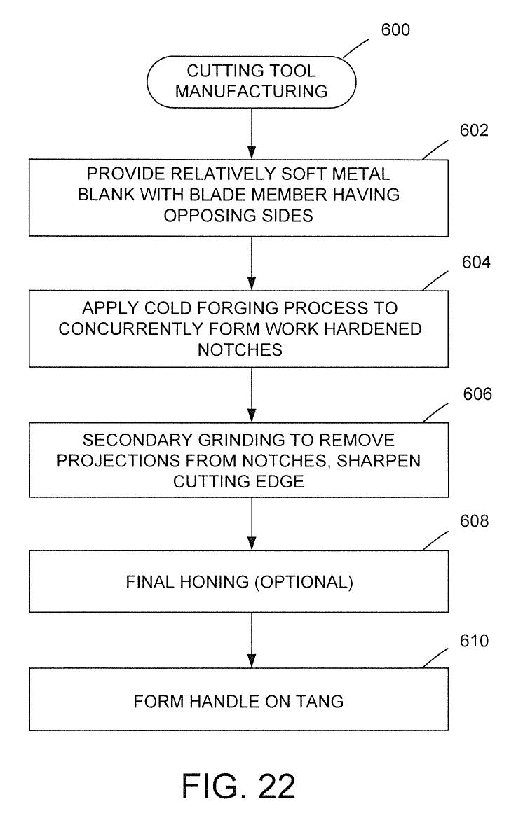

FIG. 22 is a flow chart for a cutting tool manufacturing routine 600 illustrative of steps carried out in accordance with the foregoing discussion to manufacture a cutting tool with cold forged, work hardened notches. As before, the routine is merely exemplary and may be modified as required.

At step 602, a relatively soft metal blank (such as 520, 552) is initially provided having a blade portion with opposing sides. As desired, a preliminary grinding operation may be supplied to one or both sides of the blade portion, although such is not necessarily required.

A cold forging process is carried out at step 604 to form work hardened notches. Depending on the strength and thickness of the material, some thinning of the metal material can be carried out during this step as well, even sufficiently to define a cutting edge or an approximation thereof.

Step 606 provides a secondary grinding operation to form/refine the cutting edge and to remove the projections formed from the notches. This provides well defined cutting edge and recessed cutting edge surfaces as discussed above. An optional honing operation may be carried out at step 608, and a handle may be attached at step 610.

The foregoing discussion has presented a number of ways in which cold forged work hardened notches, or notches, may be manufactured into a cutting tool or subsequently formed in an existing cutting tool. Empirical testing has established that the notches significantly extend the cutting performance of a given blade over that same blade without the presence of the notches.

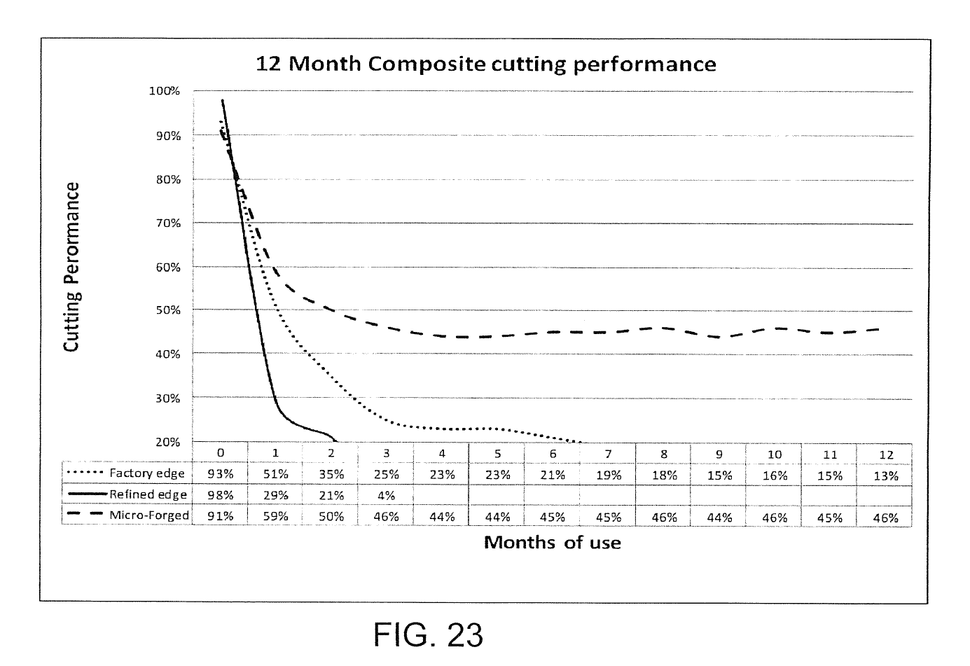

FIG. 23 provides graphical data obtained from a variety of extended cutting tests performed upon fine edge (also “refined edge” blades), coarse edge (also “factory edge” blades) and notched edge (in this case, “micro-forged” blades). As discussed above, fine edge blades are very sharp and do not have a large number of irregular portions along the cutting edge. A limitation with such blades is that the cutting edge can tend to roll over after a short period of use, thereby significantly dulling the cutting performance of the blade. A factory edge blade has a few more jagged edges and therefore resists roll over deformation of the cutting edge. The microforged blade had a fine edge and microforged notches approximately 0.005 inches in length along the cutting edge.

Generally, a test protocol was established whereby cutting efficiency could be quantified using both plunge cuts and slice cuts of specially configured test media. Repetitive dulling was applied to the respective blades at a rate calibrated to generally correspond to real-world observed usage over time in terms of elapsed months. In one case, it was empirically determined that a single pass using an applied dulling force of about 12 grams on a smooth, hard metal cylinder can correspond to the equivalent “dulling” that an ordinary user can apply to a knife during real world usage of the knife over a month (30 days). The data were normalized so that a cutting efficiency of 100% represents maximum practical cutting ability and 0% represents no practical cutting ability. Both plunge cutting and slicing efficiencies were combined into the final composite values.

As can be seen from FIG. 23, the initial testing of the respective blades in a pristine, non-dulled configuration (month 0) showed very high cutting efficiency for all three types of blades. The fine (refined) edge blade had the highest initial efficiency at 98%, followed by the coarse (factory) edge at 93% and the notched edge blade at 91%. From this it may be concluded that, for a variety of cutting methods and media, a very sharp blade with a highly refined edge may present the most effective cutting profile.

However, the refined edge was also shown to become the dullest at the fastest rate. It can be seen that the refined edge quickly dropped off to an efficiency of only about 29% after the first equivalent “month” (month 1), to only about 4% after three equivalent months (month 3), and could not practically cut the test media at all after that.

The factory edge was shown to last longer, dropping in efficiency to 51% after the first effective month (month 1) and continued to steadily decline to a final efficiency of about 13% at the end of the last test (month 12).

The notched blade blade had the lowest initial efficiency at 91%, although not significantly different from the efficiency of the pristine factory edge blade or the refine edge blade. However, the rate of decay in efficiency, after dropping to about 59% after the first effective month (month 1), maintained a reasonably high effectiveness of around 45% for the remaining duration of the test (through month 12). The notched edge blades with the notches thus exhibited significantly better cutting performance than the refined and factory edge blades over the duration of the test.

Those skilled in the art will recognized that the data from FIG. 23 generally correspond to real world performance; a truly sharp fine edge knife tends to exhibit exceptional cutting performance, but after a relatively short time tends to quickly degrade and become a knife that is relatively difficult to use because of the relatively accelerated dulling of the cutting edge. While not limiting, this rapid dulling is believed to arise from the rolling of the cutting edge along the length thereof as the relatively thin refined cutting edge encounters the cutting media (and potentially a hard cutting board supporting the media).

The use of a honing steel or other mechanism can be used before each cutting operation to maintain a fine edge knife in an efficient condition, and some experienced chefs use such a sharpening implement before each use of the knife. Many more users, however, seldom use such honing operations and suffer from dull knives. This is why, for example, many users often select a serrated knife to perform a cutting task upon a relatively fibrous medium (such as a tomato); the dulled edge of an otherwise fine edge knife designed for this task cannot usually generate sufficient tension in the fibers to pierce the skin and initiate slicing of the medium. However, serrated blades tend to be limited to slicing operations since serrated knives are not typically effective in performing plunge cuts, particularly upon materials with small fibers such as herbs, rope, etc. Serrated blades also tend to shred or tear materials (unlike fine edge knives) and are therefore inappropriate for cutting delicate materials such as fish. As will be appreciated, serrated blades are formed using a grinding operation to remove semicircular portions of material from an existing blade, and therefore do not provide either the same geometries or the work hardening benefits exemplified herein.

The coarse edge blade exhibits better long term performance than the fine edge blade, and while not limiting, this is believed to be in part due to the discontinuous nature of the cutting edge. While being subjected to the same dulling characteristics, it is believed that the irregularities in the cutting profile of a coarse edge are sufficient to enable the blade to retain some measure of cutting capability, possibly due to the fact that some portions of the cutting edge are rolled in a first direction and other portions of the cutting edge are rolled in an opposing second direction. The discontinuities between different directions of roll may therefore provide additional cutting surfaces that enhance the ability of the blade to continue to cut at a higher cutting efficiency than the unitary roll direction that may be imparted to a fine edge cutting edge.

By contrast, it has been discovered by the inventor that the use of the notches disclosed herein provides a cutting edge with superior, long lasting cutting ability. Testing results demonstrate that a cutting edge with notches, even if subjected to dulling of the sharpening segments between adjacent notches, provides the blade with the unexpected benefit of continuing to exhibit relatively consistent levels of cutting efficiency. In each case, it has been found that an existing knife, whether a fine edge knife, a coarse edge knife, a scalloped knife or a serrated knife, when provisioned with the notches as disclosed herein, obtains the unpredicted benefit of continuing to perform cuts suitable to the blade style over a significantly extended period of time. From a casual user's standpoint, the knife (of whatever type) appears to remain “sharper” longer.

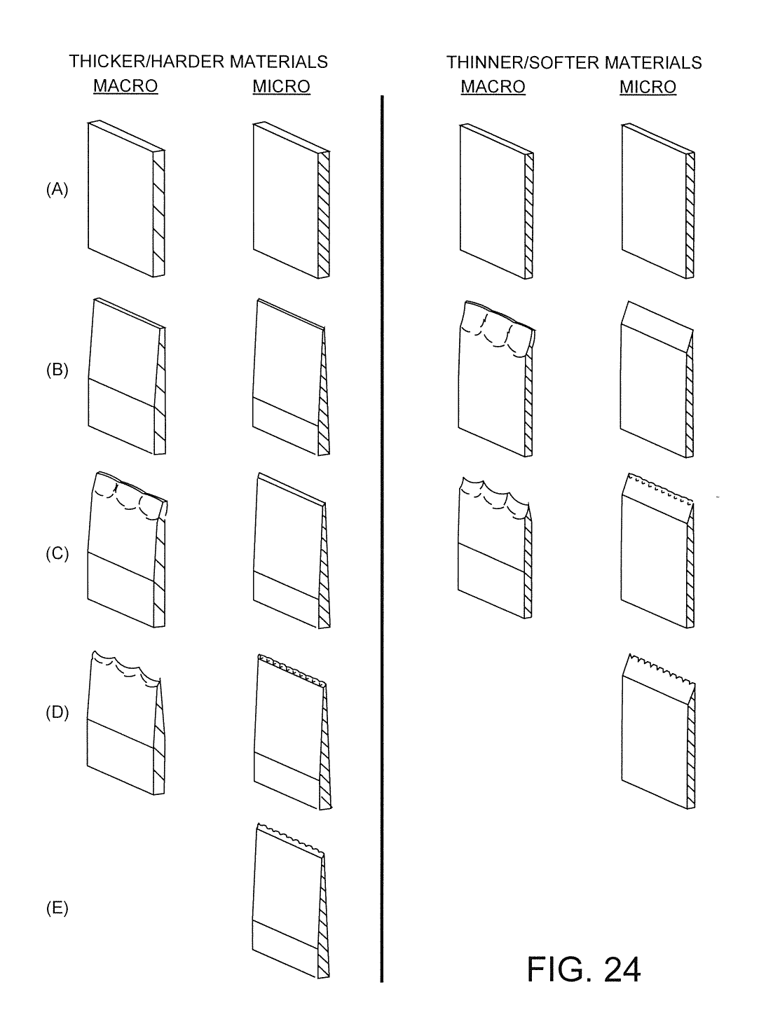

FIG. 24 provides a matrix of blade portions of a cutting tool subjected to various processing as discussed above. The blade portions are arranged into four (4) columns to represent successive types of processing operations that may be applied as required. The leftmost two columns represent blade portions of relatively thicker and/or harder metal materials, and the rightmost two columns represent blade portions of relatively thinner and/or softer materials. The first and third columns show application of macroforging notch processing, and the second and fourth columns show microforging processing.

For example, the first column shows exemplary processing to apply macroforged notches to a relatively thicker/harder material, including a blank (step (A)), primary grind (step (B), macro-forged cold forged notches (step (C)), and secondary grind (step (D)). Similar steps are shown for the remaining columns.

It can be seen from FIG. 24 that, for the relatively harder/thicker material, an initial secondary grinding operation may not be required for the macroforged notches, but may be suitable if microforged notches are applied. Compare, for example, the first two columns and note the extra step in the second column where a secondary grind operation is applied at step (C) prior to formation of the microforged notches.

Similarly, for the relatively thinner/softer material, an initial primary grinding operation may be suitable for microforged notches but may be unnecessary for the macroforged notches. Compare, for example, the third and fourth columns and note the extra step in the fourth column at step (B) where an initial primary grinding operation is applied prior to the cold forging process. Moreover, single sided grinding may be suitable for the relatively thinner and/or softer materials.

The notches disclosed herein can be applied to any number of different types and styles of cutting tools, including tools with existing features (e.g., serrations, scallops, wavy profiles, etc.) designed to enhance cutting efficiency.

It is to be understood that even though numerous characteristics and advantages of various embodiments of the present disclosure have been set forth in the foregoing description, together with details of the structure and function of various embodiments thereof, this detailed description is illustrative only, and changes may be made in detail, especially in matters of structure and arrangements of parts within the principles of the present disclosure to the full extent indicated by the broad general meaning of the terms in which the appended claims are expressed.

What is claimed is:

1. A method for shaping a cutting edge on a cutting tool having a blade portion with opposing first and second sides, the blade portion formed of a metal material, the method comprising:
placing the blade portion into a fixture having at least one form tool projection;
cold forging the blade portion by applying a force to the first side of the blade portion using the form tool projection to form a notch such that a portion of the metal material from the first side of the blade is deformed to extend through a plane along which the second side extends, the blade portion locally work hardened by the deformation of the blade portion by the form tool projection, wherein the form tool projection is a radially extending projection of a rotatable knurl roller, the knurl roller rotating during retraction of the blade portion thereacross to form a sequence of spaced apart cold forged notches along the cutting edge; and
grinding the second side of the blade portion to remove the portion of the metal material that extends beyond the plane along which the second side extends and sharpen a cutting edge extending between the first and second sides.

2. The method of claim 1, further comprising a prior step of applying a grinding operation to the blade portion to form the first and second sides as tapered surfaces that intersect to form the cutting edge along an intersection line of the first and second sides, wherein the notch extends through the cutting edge.

3. The method of claim 2, wherein the cold forging step forms a plurality of nominally identical notches that extend through the cutting edge.

4. The method of claim 1, wherein the knurl roller comprises a sequence of nominally identical, radially spaced teeth that extend from a central body rotatable about a knurl roller axis, wherein the cold forging step further comprises inducing relative rotational movement of the knurl roller relative to the tool while applying a force to each of the teeth to form a corresponding plurality of spaced apart notches such that corresponding portions of the metal material from the first side of the blade are deformed to extend through the plane along which the second side extends, the blade portion locally work hardened by the deformation of the blade portion by each of the teeth, and wherein the grinding step comprises grinding the second side of the blade portion to remove each portion of the metal material that extends beyond the plane along which the second side extends and sharpen the cutting edge extending between the first and second sides.

5. The method of claim 4, wherein the teeth are equally spaced about the knurl roller axis.

6. The method of claim 4, wherein the teeth are irregularly spaced about the knurl roller axis.

7. The method of claim 4, wherein each of the notches has a base surface that extends along a plane that is nominally parallel to the knurl roller axis.

8. The method of claim 1, wherein each of the teeth is triangular in shape.

9. The method of claim 1, wherein the grinding step comprises advancing the second side of the blade portion along an abrasive surface of an abrasive member.

10. The method of claim 9, wherein the abrasive member is a rotating abrasive disc.

11. The method of claim 9, wherein the abrasive member is a moving abrasive belt.

12. The method of claim 9, wherein the abrasive member is a stationary abrasive block.

13. The method of claim 9, wherein the abrasive member is a stationary abrasive rod.

14. The method of claim 9, wherein the abrasive member is characterized as a pair of abrasive discs.

15. The method of claim 9, wherein the abrasive member is characterized as a powered abrasive member.

16. A method for making a cutting tool, comprising:
applying a primary grinding operation to at least a first side of a blade portion formed of a metal material to thin the blade portion and form a cutting edge that extends along an intersection line between the first side of the blade portion and an opposing second side of the blade portion;
cold forging the blade portion by applying a force to the first side of the blade portion using a plurality of form tool projections to form a corresponding plurality of spaced apart notches along the cutting edge such that a portion of the metal material from a selected one of the first or second sides of the blade is deformed adjacent each notch to extend through a plane along which the remaining one of the first or second side extends, the blade portion locally work hardened by the deformation of the blade portion by each of the plurality of form tool projections, wherein the form tool projections comprise teeth extending from a knurl roller and the cold forging step comprises advancing the cutting edge of the blade portion across the knurl roller as the knurl roller rotates about a central axis; and
applying a secondary grinding operation to the remaining one of the first or second sides of the blade portion to remove the portions of the metal material that extend beyond the plane along which the remaining one of the first or second sides extends and sharpen the cutting edge extending between the first and second sides.

17. The method of claim 16, wherein the primary grinding operation comprises applying a moving abrasive surface against the at least the first side of the blade portion to form a first beveled surface along a length of the blade portion at a first angle with respect to a longitudinal axis of the blade portion.

18. The method of claim 17, wherein the secondary grinding operation comprises applying a moving abrasive surface against the at least the first side of the blade portion to form a second beveled surface along the length of the blade portion at a second angle with respect to the longitudinal axis of the blade portion greater than the first angle.

19. The method of claim 16, wherein the teeth are equally spaced about the knurl roller axis.

20. The method of claim 16, wherein the teeth are irregularly spaced about the knurl roller axis.

21. The method of claim 16, wherein the secondary grinding operation comprises applying at least a selected one of a rotating abrasive disc, a moving abrasive belt, a stationary abrasive block, a stationary abrasive rod, a pair of abrasive discs, or a powered abrasive member to the remaining one of the first or second sides of the blade portion

22. A method for making a cutting tool, comprising:
providing a blade portion formed of a metal material to which a grinding operation has not been applied, the blade portion having opposing first and second sides;
cold forging the blade portion by applying a force to the first side of the blade portion using a plurality of form tool projections to form a corresponding plurality of spaced apart notches along a length of the blade portion such that a portion of the metal material from a selected one of the first or second sides of the blade is deformed adjacent each notch to extend through a plane along which the remaining one of the first or second side extends, the blade portion locally work hardened by the deformation of the blade portion by each of the plurality of form tool projections, wherein the form tool projections extend from a knurl roller and the cutting edge of the blade portion is advanced across the knurl roller as the knurl roller rotates about a central axis; and
applying a grinding operation to the remaining one of the first or second sides of the blade portion to remove the portions of the metal material that extend beyond the plane along which the remaining one of the first or second sides extends, the grinding operation thinning the blade portion to form a cutting edge as an intersection of the first and second sides along which the notches extend.

23. The method of claim 22, wherein each of the notches has a base surface that extends along a plane that is nominally parallel to the knurl roller axis.

24. The method of claim 22, wherein each of the teeth is triangular in shape.

25. The method of claim 22, wherein the grinding operation comprises applying a moving abrasive surface against the at least the first side of the blade portion to form a first beveled surface along a length of the blade portion at a first angle with respect to a longitudinal axis of the blade portion.

26. The method of claim 22, wherein the grinding operation further comprises applying a moving abrasive surface against the at least the first side of the blade portion to form a second beveled surface along the length of the blade portion at a second angle with respect to the longitudinal axis of the blade portion greater than the first angle.
